(19) United States
(12) Patent Application Publication
(10) Pub. No.: US 2026/0230415 A1
(43) Pub. Date: Aug. 6, 2026

(54) CONFIGURATION FOR TRIGGERING RAN VISIBLE QOE REPORTING

(71) Applicant: Telefonaktiebolaget LM Ericsson (PUBL), Stockholm (SE)

(72) Inventors: Luca Lunardi, GENOVA (IT); Filip Barac, HUDDINGE (SE); Johan Rune, LIDINGÖ (SE); Agne Åberg Larsson, UPPSALA (SE); Vengatanathan Krishnamoorthi, LINKÖPING (SE); Cecilia Eklöf, TÄBY (SE)

(21) Appl. No.: 19/150,378

(22) PCT Filed: Feb. 23, 2024
(86) PCT No.: PCT/IB2024/051771

§ 371 Date: Jul. 23, 2025

Related U.S. Application Data
(60) Provisional application No. 63/486,791, filed on Feb. 24, 2023.

(51) Int. Cl. H04L 43/067; H04L 43/0805

(52) U.S. Cl. CPC H04L 43/067; H04L 43/0805

(57) ABSTRACT

A method is provided by a user equipment, UE, for trigger-based Radio Access Network-Visible Quality of Experience, RVQOE, reporting. The method includes at least one of: receiving, from a network node, a configuration for trigger-based RVQOE reporting; or transmitting, to the network node, the configuration for trigger-based RVQOE reporting. The UE transmits at least one RVQOE report based on the configuration for trigger-based RVQOE reporting.

### TECHNICAL FIELD

The present disclosure relates, in general, to wireless communications and, more particularly, systems and methods for trigger-based Radio Access Network-Visible Quality of Experience (RVQOE) reporting.

### BACKGROUND

Quality of Experience (QoE) measurements, also referred to as “application layer measurements,” have been specified for Long Term Evolution (LTE) and Universal Mobile Telecommunication System (UMTS) and were recently specified for 5^{th} Generation (5G) New Radio (NR) in the 3^{rd} Generation Partnership Project (3GPP) Release 17 (Rel-17). The purpose of the QoE measurements is to measure the experience of the end user using certain applications. Currently, the QoE measurements are specified and supported for Dynamic Adaptive Streaming over HTTP (DASH), Mobility Telephony Service for IMS (MTSI) services, and Virtual Reality (VR).

The solutions in LTE and UMTS are similar. QoE Measurement Collection (QMC) enables configuration of application layer measurements in the User Equipment (UE) and transmission of QoE measurement result files, commonly referred to as “QoE reports,” to the network by means of Radio Resource Control (RRC) signaling. An application layer measurement configuration (also called QoE measurement configuration or QoE configuration) that the Radio Access Network (RAN) receives from the Operations & Maintenance (OAM) system, or the Core Network (CN), is encapsulated in a transparent container, which is forwarded to a UE in a downlink RRCReconfiguration message. An application layer measurement report (also called a QoE report), which the UE Access Stratum (UE AS) or UE RRC layer receives from the UE's higher layer (application layer), is encapsulated in a transparent container and sent to the network in an uplink RRC message, MeasurementAppLayerReport. The RAN then forwards the QoE report to a Measurement Collector Entity (MCE).

In 3GPP Rel-17, “Study on NR QoE management and optimizations for diverse services” (with the purpose of studying solutions for QoE measurements in NR) was finalized and concluded. According to this study item, QoE management in NR will not just collect the QoE parameters of streaming services but also consider the typical performance requirements of diverse services (e.g., Augmented Reality (AR)/VR and Ultra-Reliable Low-Latency Communication (URLLC), of which at least VR was covered in 3GPP Rel-17). Based on the requirements of the services, the NR study also included more adaptive QoE management schemes that enable network optimization to satisfy user experience for diverse services.

The configuration data related to QoE measurements (in standard specifications typically referred to as application layer measurements) consists of a service type indication, an indication of an area in which the measurements are to be performed (denoted area scope), an Internet Protocol (IP) address of the entity to which the collected measurement results (i.e. the QoE reports) should be sent (often referred to as a Measurement Collector Entity or Measurement Collection Entity (MCE)), and a set of instructions indicating which type of measurements should be performed and details of how these measurements are to be performed. These instructions are intended for the application layer in the UE and are placed in a “container” that cannot be read and interpreted by the network entities that handle it by, for example, forwarding the instructions in the container to the UE. The container also cannot be read and interpreted by the UE Access Stratum. The currently specified service types are MTSI and streaming service (DASH). In 3GPP Rel-17, VR was also added. An area scope is defined in terms of cells or network related areas. In UMTS, an area scope is defined as either a list of cells, a list of routing areas, or a list of tracking areas. In LTE, an area scope is defined as either a list of cells or a list of tracking areas. In NR, an area scope is defined as either a list of cells (a list of New Radio Cell Global Identifiers (NCGIs)) or a list of tracking areas (a list of Type Allocation Codes (TACs)).

QoE, and in particular, the QoE configuration, comes in two flavors: management-based (m-based) QoE configuration and signaling-based (s-based) QoE configuration. In both cases, the QoE configuration originates in the OAM system or some other administrational entity that, for example, deals with customer satisfaction. Within this document, all of these entities are referred to as the OAM system (where the OAM system also contains further entities).

With the m-based QoE, the OAM system is typically interested in general QoE statistics from a certain area, which is configured as an area scope. The m-based QoE configuration is sent directly from the OAM system to the RAN nodes controlling cells that are within the area scope. Each RAN node then selects UEs that are within the area scope (and also fulfills any other relevant condition, such as supporting the concerned application/service type) and sends the m-based QoE configuration to these UEs.

With the s-based QoE, the OAM system is interested in collecting QoE measurement results from a specific UE such as, for example, because the user of the UE has filed a complaint. The OAM system sends the s-based QoE configuration to the Home Subscriber Server (HSS) (in Evolved Packet System (EPS)/LTE) or Unified Data Management (UDM) (in 5GS/NR), which forwards the QoE configuration to the UE's current core network node (CN) such as, for example, a Mobility Management Entity (MME) in EPS/LTE or an Application Management Function (AMF) in 5G/NR. The CN then forwards the s-based QoE configuration to the RAN node that serves the concerned UE, and the RAN node forwards the QoE configuration to the UE.

Forwarded to the UE are the service type indication and the container with the measurement instructions. The UE is not aware of whether a received QoE configuration is m-based or s-based. In legacy systems, the QoE framework is integrated with the Trace functionality and a Trace identifier (ID) is associated with each QoE configuration. In NR, the QoE functionality is logically separated from the Trace functionality, but it will still partly reuse the Trace signaling mechanisms. In NR, and possibly in LTE, a globally unique QoE reference (formed of Mobile Country Code (MCC)+Mobile Network Code (MNC)+QMC ID, where the QMC ID is a string of 24 bits) will be associated with each QoE configuration. The QoE reference is included in the container with measurement instructions and also sent to the RAN (i.e., the gNB in NR). For the communication between the gNB and the UE, the QoE reference is replaced by a shorter identifier denoted as measConfigAppLayerId, which is locally unique within a UE (i.e., there is a one-to-one mapping between a measConfigAppLayerId and a QoE reference for each QoE configuration provided to a UE). The measConfigAppLayerId is stored in the UE Access Stratum and also forwarded in an AT Command (which is the type of instructions used in the communication between the UE's modem part and the UE's application layer) together with the service type indication and the container with the measurement instructions.

Reports that include collected QoE reports are sent from the UE application layer to the UE Access Stratum, which forwards them to the RAN, which in turn forwards them to the MCE. These QoE reports are placed in a “container”, which is uninterpretable for both the UE Access Stratum and the RAN. QoE reporting can be configured to be periodic or only to be sent at the end of an application session. Furthermore, the RAN can instruct the UE to pause QoE reporting, e.g. in case the cell/gNB is in a state of overload.

The RAN is not automatically aware of when an application session with an associated QoE measurement session is ongoing, and the UE Access Stratum is also not automatically aware of this. To alleviate this, session “start”/“stop” indications were introduced. These start and stop indications are sent from the application layer in the UE to the UE AS and from the UE AS to the RAN. A session stop indication may be explicit or may be implicit in the form of a QoE report sent when the application session and the associated QoE measurement session are concluded.

The RAN may decide to release a QoE configuration in a UE at any time, as an implementation-based decision. Typically, it is done when the UE has moved outside a configured area scope.

One opportunity provided by previous solutions and techniques is to be able to keep the QoE measurement for the whole session, even during a handover situation. It is also discussed to let the UE continue with the QoE measurements on an ongoing application session until the application session ends, even if the UE in the meantime moves out of the configured area scope.

### RAN Visible QoE (RVQoE) Measurements

QoE measurements and their reported results are intended for analysis in the OAM system (or in other entities that neither belong to the core network nor belong to the RAN) and subsequent possible non-real-time optimizations. The QoE reports are transparently forwarded by the RAN to a configured receiver such as, for example, an MCE. However, the RAN could also benefit from receiving measurement results of metrics measured or collected at the application layer such as, for example, as a complement to the more radio related measurements (i.e., the RRM measurements such as, for example, Reference Signal Received Power (RSRP), Reference Signal Received Quality (RSRQ), and Signal Interference to Noise Ratio (SINR)). For instance, the RAN could use such measurement results for real-time or semi-real-time adaptations or optimizations of the treatment of an ongoing application session such as, for example, in terms of scheduling priorities.

For this reason, in 3GPP Rel-17, 3GPP introduced RAN Visible QoE, which comprises periodic reporting of measured application layer metrics in a format that the RAN can understand. In Rel-17, these metrics, which are denoted as RVQOE metrics, are limited to QoE metrics, and, in particular, to the Buffer Level QoE metric for DASH (specified in 3GPP TS 26.247 Version 17.1.0, which in turn references annex D.4.5 in ISO/IEC 23009-1, and represented in 3GPP TS 38.331 Version 17.2.0 as the AppLayerBufferLevel-r17 field) and the Playout Delay for Media Start-up QoE metric for DASH (specified in 3GPP TS 26.247 Version 17.1.0 and represented in 3GPP TS 38.331 Version 17.2.0 as the playoutDelayForMediaStartup-r17 field). In addition to these two RVQoE metrics, a MeasurementReportAppLayer message may contain a Packet Data Unit (PDU) session ID list (in the form of the pdu-SessionIdList-r17 field) as part of the reported RVQ information (i.e., in the RAN-VisibleMeasurements-r17 Information Element (IE)).

The configuration for QoE and RVQoE are performed via an RRC reconfiguration message containing the AppLayerMeasConfig IE and are shown below:

-- ASN1START
-- TAG-APPLAYERMEASCONFIG-START

| AppLayerMeasConfig-r17 ::= | SEQUENCE { | |
|---|---|---|
| measConfigAppLayerToAddModList-r17 | SEQUENCE (SIZE (1..maxNrofAppLayerMeas-r17)) OF | |
| MeasConfigAppLayer-r17 | OPTIONAL, -- Need N | |
| measConfigAppLayerToReleaseList-r17 | SEQUENCE (SIZE (1..maxNrofAppLayerMeas-r17)) OF | |
| MeasConfigAppLayerId-r17 | OPTIONAL, -- Need N | |
| rrc-SegAllowed-r17 | ENUMERATED {enabled} | OPTIONAL, -- Need R |

...
}

| MeasConfigAppLayer-r17 ::= | SEQUENCE { | |
|---|---|---|
| measConfigAppLayerId-r17 | , | |
| measConfigAppLayerContainer-r17 | OCTET STRING (SIZE (1..8000)) | OPTIONAL, -- Need |

N

| | |
|---|---|
| serviceType-r17 | ENUMERATED {streaming, mtsi, vr, spare5, spare4, spare3, spare2, spare1} |

OPTIONAL, -- Need M

| | | |
|---|---|---|
| pauseReporting-r17 | BOOLEAN | OPTIONAL, -- Need M |
| transmissionOfSessionStartStop-r17 | BOOLEAN | OPTIONAL, -- Need M |
| ran-VisibleParameters-r17 | SetupRelease {RAN-VisibleParameters-r17} | OPTIONAL, -- |

Cond ServiceType
...
}

| | |
|---|---|
| RAN-VisibleParameters-r17 ::= | SEQUENCE { |
| ran-VisiblePeriodicity-r17 | ENUMERATED {ms120, ms240, ms480, ms640, ms1024} |

OPTIONAL, -- Need S

| | | |
|---|---|---|
| numberOfBufferLevelEntries-r17 | INTEGER (1..8) | OPTIONAL, -- Need R |
| reportPlayoutDelayForMediaStartup-r17 | BOOLEAN | OPTIONAL, -- Need M |

...
}
-- TAG-APPLAYERMEASCONFIG-STOP
-- ASN1STOP

Specifically, in the above, the configuration of legacy QoE metrics is done via the measConfigAppLayerContainer IE, which specifies the configuration to the application-layer in the UE as an octet string (following XML). RVQOE parameters are specified as part of the RAN-VisibleParameters IE.

### Support of Event-Based RVQOE Reporting.

As part of Release 18 (Rel-18) normative work, the RAN3 Working Group is discussing the support for triggered based and event-based RVQoE reporting. In terms of event-based RVQoE reporting trigger, some proposals have been made. For example, it has been proposed to report RVQoE measurements upon fulfillment of radio related events (as defined in 3GPP TS 38.331 v17.3.0). But, no agreements have been settled so far.

In terms of RVQoE reporting, a gNB can configure the UE to report RVQoE measurements based on a certain periodicity (as defined by the ran-VisiblePeriodicity IE in TS 38.331).

In one contribution to RAN3 119 meeting (R3-230371), three different options were proposed for determining the buffer level measurement periodicity:
In Rel-17, the buffer level measurement periodicity is calculated by the UE APP as the buffer level reporting periodicity divided by number OfBufferLevelEntries. But if threshold-based reporting for buffer level is configured by NG-RAN node in Rel-18, it might not configure the reporting periodicity.
Proposal 5: RAN3 should confirm that ran-VisiblePeriodicity (reporting periodicity) will not be configured in case threshold-based triggers are used for reporting RVQoE metrics (e.g., buffer level).
If Proposal 5 is agreed, then it is not clear how frequently that the buffer level should be measured at UE APP for RVQoE reporting.
By default, the buffer level will be measured every n seconds (as configured by the container-based QoE) and can be measured more frequently (ran-VisiblePeriodicity divided by numberOfBufferLevelEntries) in case periodic reporting is configured. In case of threshold-based reporting, the following options can be considered for determining the buffer level measurement periodicity:
   Option 1: NG-RAN explicitly configures the buffer level measurement periodicity in case threshold-based triggers are configured.
   Option 2: Same as configured by the container-based QoE (every n seconds)
   Option 3: Up to UE implementation

There currently exist certain challenge(s), however. For example, it remains to be discussed and decided how to handle the threshold- and event-triggered reporting of RVQoE measurements.

### SUMMARY

Certain aspects of the disclosure and their embodiments may provide solutions to these or other challenges. For example, methods and systems are provided for trigger-based RVQOE reporting.

According to certain embodiments, a method by a UE, for trigger-based RVQOE reporting includes receiving, from a network node, a configuration for trigger-based RVQOE reporting or transmitting, to the network node, the configuration for trigger-based RVQOE reporting. The method also includes the UE transmitting at least one RVQOE report based on the configuration for trigger-based RVQOE reporting.

According to certain embodiments, a UE, for trigger-based RVQOE reporting is configured to receive, from a network node, a configuration for trigger-based RVQOE reporting or transmit, to the network node, the configuration for trigger-based RVQOE reporting. The UE is configured to transmit at least one RVQOE report based on the configuration for trigger-based RVQOE reporting.

According to certain embodiments, a method by a network node for trigger-based RVQOE reporting includes transmitting, to a UE, a configuration for trigger-based RVQOE reporting or receiving, from the UE, the configuration for trigger-based RVQOE reporting. The method also includes the network node receiving at least one RVQOE report based on the configuration for trigger-based RVQOE reporting.

According to certain embodiments, a network node for trigger-based RVQOE reporting is configured to transmit, to a UE, a configuration for trigger-based RVQOE reporting or receive, from the UE, the configuration for trigger-based RVQOE reporting. The network node is configured to receive at least one RVQOE report based on the configuration for trigger-based RVQOE reporting.

Certain embodiments may provide one or more of the following technical advantage(s). For example, certain embodiments may provide a technical advantage of enabling a flexible control in the reporting of RVQoE measurements when based on fulfillment of thresholds related to RVQOE metric values (threshold-based triggered RVQoE reporting) or when the reporting of RVQOE measurements is based on events of which fulfillment is determined by the UE or the RAN (event-based triggered RVQoE reporting).

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates an example communication system, according to certain embodiments;

FIG. 2 illustrates an example UE, according to certain embodiments;

FIG. 3 illustrates an example network node, according to certain embodiments;

FIG. 4 illustrates a block diagram of a host, according to certain embodiments;

FIG. 5 illustrates a virtualization environment in which functions implemented by some embodiments may be virtualized, according to certain embodiments;

FIG. 6 illustrates a host communicating via a network node with a UE over a partially wireless connection, according to certain embodiments;

FIG. 7 illustrates an example method by a UE for trigger-based RVQOE reporting, according to certain embodiments;

FIG. 8 illustrates another example method by a UE for trigger-based RVQOE reporting, according to certain embodiments

FIG. 9 illustrates an example method by a network node for trigger-based RVQOE reporting, according to certain embodiments; and

FIG. 10 illustrates another example method by a network node for trigger-based RVQOE reporting, according to certain embodiments.

### DETAILED DESCRIPTION

Some of the embodiments contemplated herein will now be described more fully with reference to the accompanying drawings. Embodiments are provided by way of example to convey the scope of the subject matter to those skilled in the art.

As used herein, ‘node’ can be a network node or a UE. Examples of network nodes are Radio Access Network (RAN) node, NodeB, base station (BS), multi-standard radio (MSR) radio node such as MSR BS, eNodeB (eNB), gNodeB (gNB), Master eNB (MeNB), Secondary eNB (SeNB), en-GNB, Next Generation eNB (ng-eNB), eNB-Centralized Unit-Control Plane (eNB-CU-CP), eNB-Centralized Unit-User Plane (eNB-CU-UP), integrated access backhaul (IAB) node, IAB-donor Distributed Unit (DU), IAB-donor Centralized Unit (CU), IAB-DU, IAB-Mobile Termination (IAB-MT), O-RAN Centralized Unit (O-CU), O-RAN-CU-Control Plane (O-CU-CP), O-RAN-CU-User Plane (O-CU-UP), O-RAN Distributed Unit (O-DU), O-RAN-Radio Unit (O-RU), O-RAN-eNB (O-eNB), network controller, radio network controller (RNC), base station controller (BSC), a Non-Real Time RAN Intelligent Controller (Non-RT RIC), a Real-Time RAN Intelligent Controller (RT-RIC), relay, donor node controlling relay, base transceiver station (BTS), Central Unit (e.g., in a gNB), Distributed Unit (e.g., in a gNB), Baseband Unit, Centralized Baseband, C-RAN, access point (AP), transmission points, transmission nodes, Remote Radio Unit (RRU), Remote Radio Head (RRH), nodes in distributed antenna system (DAS), core network node (e.g., Mobile Switching Center (MSC), Mobility Management Entity (MME), etc.), Operations & Maintenance (OAM), Operations Support System (OSS), Self Organizing Network (SON), positioning node (e.g., E-SMLC), etc.

Another example of a node is user equipment (UE), which is a non-limiting term and refers to any type of wireless device communicating with a network node and/or with another UE in a cellular or mobile communication system. Examples of UE are target device, device-to-device (D2D) UE, vehicular-to-vehicular (V2V), machine type UE, Machine Type Communications (MTC) UE or UE capable of machine to machine (M2M) communication, Personal Digital Assistant (PDA), Tablet, mobile terminals, smart phone, laptop embedded equipment (LEE), laptop mounted equipment (LME), Unified Serial Bus (USB) dongles, etc.

In some embodiments, generic terminology, “radio network node” or simply “network node (NW node)”, is used. It can be any kind of network node which may comprise base station, radio base station, base transceiver station, base station controller, network controller, evolved Node B (eNB), Node B, gNodeB (gNB), relay node, access point, radio access point, Remote Radio Unit (RRU) Remote Radio Head (RRH), Central Unit (e.g., in a gNB), Distributed Unit (e.g., in a gNB), Baseband Unit, Centralized Baseband, C-RAN, access point (AP), etc.

The term radio access technology (RAT), may refer to any RAT such as, for example, Universal Terrestrial Radio Access Network (UTRA), Evolved Universal Terrestrial Radio Access Network (E-UTRA), narrow band internet of things (NB-IoT), WiFi, Bluetooth, next generation RAT, NR, 4G, 5G, etc. Any of the equipment denoted by the terms node, network node or radio network node may be capable of supporting a single or multiple RATs.

The term signal or radio signal used herein can be any physical signal or physical channel. Examples of DL physical signals are reference signal (RS) such as Primary Synchronization Signal

(PSS), Secondary Synchronization Signal (SSS), Channel State Information-Reference Signal (CSI-RS), Demodulation Reference Signal (DMRS) in SS/PBCH block (SSB), discovery reference signal (DRS), Cell Specific Reference Signal (CRS), Positioning Reference Signal (PRS), etc. RS may be periodic. For example, RS occasions carrying one or more RSs may occur with certain periodicity such as, for example, every 20 ms, 40 ms, etc. The RS may also be aperiodic. Each SSB carries NR-PSS, NR-SSS and NR-PBCH in 4 successive symbols. One or multiple SSBs are transmit in one SSB burst which is repeated with certain periodicity such as, for example, 5 ms, 10 ms, 20 ms, 40 ms, 80 ms, and 160 ms. The UE is configured with information about SSB on cells of certain carrier frequency by one or more SS/PBCH block measurement timing configuration (SMTC) configurations. The SMTC configuration comprising parameters such as SMTC periodicity, SMTC occasion length in time or duration, SMTC time offset with regard to reference time (e.g., serving cell's SFN), etc. Therefore, SMTC occasions may also occur with certain periodicity such as, for example, 5 ms, 10 ms, 20 ms, 40 ms, 80 ms, and 160 ms. Examples of uplink (UL) physical signals are reference signal such as Sounding Reference Signal (SRS), DMRS, etc. The term physical channel refers to any channel carrying higher layer information such as, for example, data, control, etc. Examples of physical channels are Physical Broadcast Channel (PBCH), Narrowband PBCH (NPBCH), Physical Downlink Control Channel (PDCCH), Physical Downlink Shared Channel (PDSCH), Physical Uplink Control Channel (PUCCH), Physical Uplink Shared Channel (PUSCH), shortened PUCCH (sPUCCH), shortened PDSCH (SPDSCH), shortened PUCCH (sPUCCH), shortened PUSCH (sPUSCH), MTC PDCCH (MPDCCH), Narrowband PDCCH (NPDCCH), Narrowband PDSCH (NPDSCH), E-PDCCH, Narrowband PUSCH (NPUSCH), etc.

The term time resource used herein may correspond to any type of physical resource or radio resource expressed in terms of length of time. Examples of time resources are: symbol, time slot, subframe, radio frame, TTI, interleaving time, slot, sub-slot, mini-slot, system frame number (SFN) cycle, hyper-SFN (H-SFN) cycle, etc.

Herein, the terms “application layer measurement configuration,” “application measurement configuration,” “QoE measurement configuration,” “QoE configuration,” “QoE measurement and reporting configuration,” and “QMC configuration” are used interchangeably. But note that the “QMC configuration file” is not an equivalent term, and instead refers to the part of the QoE configuration consisting of an XML file containing instructions of QoE metrics to be collected.

Herein, the terms “QoE report” and “QoE measurement report” are used interchangeably. Similarly, the terms “RAN Visible QoE report,” “RAN Visible QoE measurement report,” “RVQoE report,” and “RVQoE measurement report” are used interchangeably.

The terms “QoE configuration” and “QoE measurement configuration” are used interchangeably. Similarly, the terms “RVQoE configuration” and “RVQoE measurement configuration” are used interchangeably.

The terms “access stratum” and “radio layer” are used interchangeably when referring to a UE.

Though certain embodiments are presented in the example context of a UE in dual connectivity, the solutions and techniques described herein may also apply to radio access technologies where the UE is served by more than two connectivity legs.

Certain embodiments apply to NR as well as future RATs such as 6G, with the IAB-MT, a parent backhaul link terminating function, and the IAB-DU, an access service providing function of a relay node.

As used herein the phrase “Sending reports to a node” may or may not mean that the said node is the consumer, i.e., the end destination of the reports.

Herein, the terms “node” and “network node” are used interchangeably herein. Herein, the terms “management-based QoE configuration” and “m-based QoE configuration” are used interchangeably.

The term “triggered reporting” applies to both threshold- and event-based reporting.

The terms “reporting triggers,” “triggers,” and “triggering conditions” are used interchangeably. In other words, unless explicitly stated otherwise, they apply to both threshold- and event-based reporting triggers.

As discussed above, as part of Release 18 (Rel-18) normative work, the RAN3 Working Group is discussing the support for triggered based and event-based RVQoE reporting, which includes sending of RVQoE reports (from UE Application Layer to UE Access Stratum, and/or from UE Access Stratum to the RAN) is triggered by an occurrence of an event, or by fulfillment of a threshold. According to certain embodiments, for example, the sending of the RVQoE reports may be based on buffer level. Another threshold-based trigger for reporting playout delay for media startup has not been agreed. It remains to be decided how to handle the threshold- and event-triggered reporting of RVQoE measurements. Some questions are:
How to stop the threshold/event-based reporting?
How long/often should the triggered reporting proceed?

For example, after threshold- or event-based RVQoE reporting is triggered, it is unclear when the reporting should stop and whether this reporting should proceed periodically from now on, or whether the report should be sent only once or multiple times.

According to certain embodiments, methods and systems are provided for providing a RVQoE configuration that indicates how frequently and/or for how long (or how many) RVQoE reports are to be sent from UE Application Layer to UE Access Stratum (or from UE Access Stratum to RAN) when the reporting of RVQoE measurements is based on fulfillment of thresholds for RVQoE metrics or fulfillment of events (as detected by UE or RAN or both).

According to certain embodiments, for example, a UE that is configured and/or adapted to perform RVQoE measurements receives instructions to be used for trigger-based RVQoE reporting. The instructions provide the means to control the sending of RVQOE reports from the

UE application layer to the UE Access Stratum, and/or the sending of RVQoE reports from the UE Access Stratum to the RAN, when threshold-based triggers or event-based triggers are used as criteria to start RVQoE reporting. Following the provided reporting instructions, the UE knows how many RVQoE reports should be sent and/or when to stop or pause or resume the sending of such reports.

The solutions and techniques disclosed herein are presented using the example of RVQoE, but are equally applicable to QoE measurements and reporting as well.

### Methods and Techniques Performed in or by the UE

According to certain embodiments, UE capability signalling is defined to indicate to the network which of the features described herein the UE is able to support. UE capability can be related to UE Access Stratum, QoE Measurement Collection (QMC), and/or UE application layer.

In a particular embodiment, for example, the UE receives configuration parameter(s) configuring one or more of the following:
Threshold- and event-based triggers for RVQoE reporting.
   Upon the fulfillment thereof, trigger-based RVQoE reporting can start
Reporting instructions for trigger-based reporting.
   These instructions indicate to the UE how to execute the triggered reporting such as, for example, whether to send one or multiple reports, whether to continue reporting periodically, when to stop reporting, when to pause or resume reporting, and the conditions thereof.

In a further particular embodiment, a UE receives, from a first RAN node, a configuration for trigger-based RVQoE reporting, which comprises a set of reporting instructions for trigger-based RVQoE reporting. The instructions configure the sending of RVQoE reports when threshold-based triggers and/or event-based triggers are used to trigger RVQoE reporting.

The Threshold- and Event-Based Triggers for RVQoE Reporting (i.e., when to Start Reporting)

In a particular embodiment, a threshold-based trigger is detected by the UE application layer on one (or more) QoE/RVQoE metric, and is determined as fulfilled, when one (or more) QoE/RVQoE metric (or portion of a metric) has a value above a first threshold, or below a first threshold, or between a first threshold and a second threshold, or outside a range defined by a first (lower) threshold and a second (upper) threshold. The threshold may also be defined on the value of a function whose value is derived based on one (or more) QoE/RVQoE metrics or as a property of time series of one or more QoE/RVQOE metrics such as, for example, a slope of metric satisfies a threshold for a certain time period. This may be defined, for example, as a time derivative of a QoE metric, or the second (or third etc.) time derivative of a QoE metric. It may also be defined as an average (e.g., a weighted average) of a set of QoE metric values, or a sliding average (e.g., an exponential average) of QoE metric values. A threshold-based trigger may also be detected at the UE Access Stratum (AS) layer. For example, a radio signal strength below a certain threshold may trigger the sending of an RVQoE report.

An event-based trigger is intended as a trigger, as detected by the UE application layer, or by the UE Access Stratum, or by both, or by the RAN, which is determined as fulfilled, when for example one of the following has occurred:
the entering conditions or the exiting conditions are fulfilled for an event associated to radio related measurements (e.g., an event A2 or A3, as defined in 3GPP TS 38.331 v17.3.0);
alignment/correlation between QoE/RVQoE measurements and radio measurements is initiated or terminated;
UE is reconfigured from single connectivity to dual connectivity (or vice versa);
UE is reconfigured to use Multicast Radio Bearer (MRB) instead of Data Radio Bearer (DRB) (or vice versa);
a UE Access Stratum is transitioning from one RRC state to another RRC state;
a UE Access Stratum is transitioning from a non-RRC connected state to RRC CONNECTED state (or vice versa);
an energy saving action is initiated/terminated;
a RAN overload condition is entered/exited;
a UE handover or other mobility procedure;
   handover type, e.g., NG-based, Xn-based handover, with and/or without conditional handover configured and with and/or without dual active protocol stack configured;
   inter-RAT handover;
radio link failure on one or both of the dual-connectivity legs;
random access failure;
RRC reestablishment is performed;
RRC resume is performed; and/or
the UE entering a certain area, for example a cell, a geographical area, a Public Land Management Network (PLMN), a tracking area (TA).

An example set of reporting instructions for trigger-based RVQoE reporting_is described below.

The Use of RVQoE Reporting Instructions (i.e., how/for how Long to Report and when to Stop)

According to certain embodiments, a set of reporting instructions for trigger-based RVQoE reporting is used, when one or more threshold-based trigger is fulfilled, and/or when one or more event-based trigger(s) is fulfilled to achieve one of the following:
to control the sending of RVQoE reports from the UE application layer to the UE Access Stratum;
to control the sending of RVQoE reports from the UE Access Stratum to a RAN node; and/or
to control the sending of RVQoE reports both from the UE application layer to the UE Access Stratum as well as the sending from the UE Access Stratum to a RAN node.

Example reporting instructions for controlling RVQoE reporting are described in more detail below.

### The Set of Reporting Instructions for Trigger-Based RVQoE Reporting

According to various certain embodiments, the set of reporting instructions for trigger-based RVQoE reporting can be delivered to the UE together with the RVQoE measurement configuration or separately from it.

For example, in various particular embodiments, the set of reporting instructions for trigger-based RVQoE reporting can comprise one or more or a combination of the following:
an instruction to unconditionally start RVQoE reporting immediately;
an indication of the RVQOE metric(s) to which the set of RVQOE reporting instructions apply. In one example, relating the RVQoE reporting to the buffer level in the application layer, where the UE e.g. starts the RVQoE reporting when the buffer level is below a certain threshold;
an indication of the number of reports to be transmitted upon fulfillment of a trigger condition;
an indication of a time interval during which the sending of RVQoE reports is required after fulfillment of a trigger condition;
an indication to collect RVQoE metrics and include them (or collect RVQoE reports and include them) as part of an UE report until the UE report is fetched by a network node;
an indication of an absolute time until when the sending of RVQoE report is required after fulfillment of a trigger condition;
an indication to send RVQoE report until a timer expires;
an indication to send RVQoE report, starting from fulfillment of a trigger condition and ending after a timer expires, the timer starting upon fulfillment of the trigger condition;
an indication to send RVQoE report, starting from fulfillment of a trigger condition and ending after a timer expires, the timer already running when the trigger condition is fulfilled;
an indication to send RVQoE report, starting from fulfillment of a trigger condition and the UE is connected to (or camped on) a first cell, and ending when the UE connects to (or reselects) a second cell;
an indication to send RVQoE report only once (one-shot reporting) or whenever, from now on, when a condition is fulfilled;
an indication of a reporting periodicity that is different from the existing RVQoE reporting periodicity define by ran-VisiblePeriodicity;
an indication of a reporting periodicity that is derived from the existing RVQoE reporting periodicity defined by ran-VisiblePeriodicity (including the two reporting periodicities being equal);
an indication of a reporting periodicity that is derived from a measurement periodicity (or from a sampling periodicity) used by the UE application layer to measure a certain RVQoE metric (including the two periodicities being equal);
an indication of a reporting periodicity that is derived from a sampling periodicity used by the UE application layer to derive/calculate/obtain a certain RVQoE metric (including the two periodicities being equal);
an indication to include an RVQoE report or a part thereof into an existing UE report (e.g., a Radio Link Failure (RLF) report, a Random Access (RA) report, a Successful Handover Report (SHR), a Successful PSCell Change/Addition report (SPR), a Connection Establishment Failure report (CEF));
an indication of a maximum number of times a certain event or threshold may trigger RVQoE reporting before the event or threshold configuration should become invalidated or discarded;
an explicit instruction to stop the triggered reporting:
   Optionally, with an instruction whether this implies that the triggering conditions for reporting:
      have become obsolete, or
      are still valid, e.g., until the condition is fulfilled again, or
      should be regarded as invalid for a time period T and then become valid again, where T may be indicated in the instruction or may be a time period specified in a standard,
      Note that the range possible instruction options may include only a subset of the above, e.g. depending on which options are supported in a related standard.
an implicit instruction to stop the triggered reporting:
   For example, providing another RVQoE configuration with the same measConfigAppLayerId (which maps to the same QoE reference) as the existing one, and without the reporting triggering conditions, implies that the conditions are no longer valid, and that triggered reporting shall stop;
an explicit instruction to pause or resume the triggered reporting; and/or
a new set of triggering conditions, replacing the current set of conditions for triggering the reporting, or updating it

In certain particular embodiments, the periodicity to use for periodic RVQoE reporting triggered by the occurrence of an event or the fulfillment of a threshold (i.e. that a concerned QoE metric goes below or above a threshold depending on the definition of the threshold) is indicated as an RVQoE configuration parameter associated with (or part of) the configuration of event or threshold triggered RVQoE reporting. In a particular embodiment, this periodicity indication can be optional, and if it is absent, the UE application uses the periodicity configured for periodic RVQoE reporting for the same service type (and application session). As yet another option, if the explicit periodicity indication (associated with, or part of, the configuration of event or threshold triggered RVQoE reporting) and there is no periodic RVQoE reporting configured for the same service type (or for the same application session), then the UE application generates and sends only one RVQoE report when the event occurs or the threshold is fulfilled.

In various particular embodiments, the set of reporting instructions for trigger-based RVQoE reporting may further include one or more or a combination of the following:
An instruction to start sending RVQoE reports when:
   the value of at least one or at least more than one RVQoE metric is above a threshold,
   the value of at least one or at least more than one RVQoE metric is below a threshold,
   the value of at least one or at least more than one RVQoE metric is between a first threshold and a second threshold,
   the value of at least one RVQoE metric is outside a range comprised between a first threshold and a second threshold,
   in one option the threshold is defined with a max and a min value where the threshold is considered as being within the max and the min value,
   any of the above, but with the RVQoE metric replaced by an average of a set of sampled values of the RVQoE metric (i.e. a set of samples):
      an average of a certain number of samples,
      a weighted average of a certain number of samples,
      an average of the samples,
      a weighted average of a certain number of samples,
      a sliding average, and/or
      an exponential average,
   any of the above, but with the RVQOE metric replaced by the time derivative (or the second, third or N^{th} time derivative) of the RVQoE metric,
   the value fulfilling any of the above for a TTT (time-to-trigger) duration of time. In one option, the measured time starting over again, if the value comes outside the defined range during the TTT,
   the value of a function whose value is derived based on at least one or at least more than one RVQoE metric is above or below a threshold,
   the value of a function as a property of the time-series of at least one or at least more than one RVQoE metric, for e.g., slope of metric satisfies a threshold for a certain time-period or number of samples:
      the trend of at least one or at least more than one RVQoE metric follows a certain pattern,
   the value of a metric or a function applied to one or more metrics (where the metrics in this case are not RVQOE metrics but other metrics that are accessible at the application or the AS) is above or below a threshold, and/or
   any of the above where the conditional sending of RVQoE reports (e.g. to start sending based on a condition) is replaced by conditional logging of RVQoE measurement results,
an instruction to stop sending RVQoE reports when:
   the value of at least one RVQoE metric is above a threshold,
   the value of at least one RVQoE metric is below a threshold,
   the value of at least one RVQoE metric is between a first threshold and a second threshold,
   the value of at least one RVQoE metric is outside a range comprised between a first threshold and a second threshold,
   any of the above, but with the RVQoE metric replaced by an average of a set of sampled values of the RVQoE metric (i.e. a set of samples):
      an average of a certain number of samples,
      a weighted average of a certain number of samples,
      an average of the samples,
      a weighted average of a certain number of samples,
      a sliding average,
      an exponential average,
   any of the above, but with the RVQoE metric replaced by the time derivative (or the second, third or N^{th} time derivative) of the RVQoE metric,
   The value being outside the range for a TTT (time-to-trigger) duration of time. In one option, the measured time starting over again, if the value comes inside the defined range during the TTT
   in one variant, the indication may refer to pausing the reporting. In one option with a condition defining when it should resume
   the value of a function whose value is derived based on at least one or at least more than one RVQoE metric is above or below a threshold
   the value of a function as a property of the time-series of at least one or at least more than one RVQOE metric, for e.g., slope of metric satisfies a threshold for a certain time-period or number of samples
      the trend of at least one or at least more than one RVQoE metric follows a certain pattern
   the value of a metric or a function applied to one or more metrics (where the metrics in this case are not RVQoE metrics but other metrics that are accessible at the application or the AS) is above or below a threshold
   any of the above where the conditional stopping of RVQOE reporting (e.g. to stop based on a condition) is replaced by conditional stopping of logging of RVQoE measurement results
an instruction to start (or resume, or stop, or pause) sending RVQoE reports upon fulfillment of the entering condition for an event
an instruction to stop (or pause, or start, or resume) sending RVQoE reports upon fulfillment of the exiting condition for an event
in one option, the CondReconfigToAddMod being used to define the conditions for RVQOE reporting. In this option the UE applies a message, RRCReconfiguration, when the condition(s) are fulfilled and that message may contain the configuration of the transmission of the RVQoE reports.
an instruction to start (or stop, or pause, or resume) sending RVQoE reports upon transition of the UE from a non-RRC connected state to an RRC connected state
an instruction to stop (or start, or pause, or resume) sending RVQoE reports upon transition of the UE from a RRC connected state to a non-RRC connected state
an instruction to start (or stop, or pause, or resume) sending RVQoE reports upon transition of the UE a certain RRC state to another RRC state
an instruction to start (or stop, or pause, or resume) sending RVQoE reports upon initiation (or termination) of alignment/correlation between QoE/RVQoE measurements and radio measure
an instruction to start (or stop, or pause, or resume) sending RVQoE reports upon reconfiguration of the UE from single connectivity to dual connectivity (or vice versa)
an instruction to start (or stop, or pause, or resume) sending RVQoE reports upon (re) configuration from using MRB instead of DRB (or vice versa)
an instruction to start (or stop, or pause, or resume) sending RVQoE reports upon initiation (or termination) of an energy saving action
an instruction to start (or stop, or pause, or resume) sending RVQoE reports upon entering (or exiting) a RAN overload condition
any of the above where the conditional sending of RVQoE reports (e.g. to start or stop or pause or resume based on a condition) is replaced by conditional logging of RVQoE measurement results

Based on the above, in a possible example embodiment, the RVQoE configuration can instruct the UE application layer to initiate the sending of RVQoE reports as soon as the buffer level value (RVQoE metric) is below a first threshold and to continue reporting the buffer level value until the buffer level value becomes higher than a second threshold.

In another example embodiment, the RVQoE configuration can indicate to the UE application to start sending periodic RVQoE reports when the concerned QoE metric goes below a threshold (e.g. when a buffer level goes below a buffer level threshold), but when the QoE metric (e.g. buffer level) returns above the threshold, the RVQoE configuration stipulates that the application should generates and send N more periodic reports and then stop reporting, unless the QoE metric (e.g. buffer level) goes below the threshold again before the N reports have been sent, in which case the process restarts, i.e. periodic reporting starts and continues until the QoE metric (e.g. buffer level) goes above the threshold, after which N periodic reports are sent, etc.
In a variation of this example embodiment, the threshold triggering continuous periodic RVQoE reporting is denoted as a first threshold, and a second threshold is used to trigger the switch from continuous periodic reporting to N periodic report, wherein this second threshold is set to a higher value than the first threshold in order to create a hysteresis.

In a similar example embodiment, the RVQoE configuration can indicate to the UE application to start sending periodic RVQoE reports when the concerned QoE metric goes above a threshold, but when the QoE metric returns below the threshold, the RVQoE configuration stipulates that the application should generates and send N more periodic reports and then stop reporting, unless the QoE metric goes above the threshold again before the N reports have been sent, in which case the process restarts, i.e. periodic reporting starts and continues until the QoE metric goes below the threshold, after which N periodic reports are sent, etc.
In a variation of this example embodiment, the threshold triggering continuous periodic RVQoE reporting is denoted as a first threshold, and a second threshold is used to trigger the switch from continuous periodic reporting to N periodic report, wherein this second threshold is set to a lower value than the first threshold in order to create a hysteresis.

In another example of embodiment, the RVQoE configuration can indicate to the UE application layer to initiate the sending of RVQoE reports as soon as the buffer level value (RVQoE metric) is below a first threshold and continue to send “N” RVQoE reports.

In the examples of embodiments above where a number of RVQoE reports, N, is configured, an option is that N may be optional to configure, and if it is absent, the UE assumes the default value N=1.

In another example of embodiment, the RVQoE configuration can indicate to the UE application layer to initiate the sending of RVQoE reports as soon as the UE is reconfigured from using Data Radio Bearer (DRB) to use Multicast Radio Bearer (MRB) (or vice versa).

### RAN Embodiments

### First RAN Node Sending the Configuration to the UE

In a particular embodiment, a first RAN node sends to a UE a set of reporting instruction for trigger-based RVQoE reporting (as defined in 7.1.1.5) to configure the UE to control the sending of RVQoE reporting from the UE to the RAN (from UE application layer to UE Access Stratum, or from the UE Access Stratum to the RAN, or from both the UE application layer to the UE AS and then from the UE AS to the RAN) when threshold-based and/or event-based triggers are used for RVQoE reporting,

In non-limiting example particular embodiments, this can be realized as part of:
an RRC Reconfiguration procedure, or
an RRC Setup procedure, or
an RRC connection reestablishment procedure, where the RAN node provides to
the UE the first/second set of RVQoE reporting configuration parameters as part of an RRCReconfiguration message, or
as part of an RRCSetup message, or
as part of an RRCReestablishment message.
   First RAN Node Retrieving the Configuration from the UE

In another particular embodiment, a first RAN node, receives from a UE a RVQoE configuration comprising a reporting instructions for trigger-based RVQoE reporting.

In some non-limiting example embodiments, this can be realized as:
part of an RRC UE Information procedure, or
an RRC Setup procedure, or an RRC connection resume procedure, or.
an RRC connection Reestablishment procedure, where the RAN node receives from the UE the set of reporting instructions for trigger-based RVQoE reporting as part of an RRC UEInformationResponse message, or
as part of an RRCResumeComplete message, or as part of an RRCSetupComplete message, or
as part of an RRCReestablishmentComplete message.

The first RAN node may have requested the UE to provide the above configuration, for instance, as part of an RRC UEInformationRequest message included in an RRC UE Information procedure.

### Configuration Exchanged Between a First RAN Node and a Second RAN Node

In another particular embodiment, pertaining to UEs in NR-DC or single-connected UEs served by a split gNB node, a first RAN node, sends (or receives) from a second RAN node a RVQoE configuration pertaining to a UE, and comprising a set of reporting instructions for trigger-based RVQoE reporting and the information is encoded according to the application protocol used between the two RAN nodes.

In one case, this embodiment can be realized as part of:
an inter-RAN node procedure (e.g., an Handover Preparation XnAP procedure, or
a Retrieve UE Context XnAP procedure), where the first RAN node sends (or receives) from the second RAN node the set of reporting instructions for RVQoE for a UE and the information is encoded according to the application protocol used between the two RAN nodes.

In another embodiment, pertaining to UEs in NR-DC or single-connected UEs served by a split gNB node, a first RAN node, sends (or receives) from a second RAN node a RVQoE configuration pertaining to a UE, and comprising a set of reporting instructions for trigger-based RVQoE reporting, and the information is encoded as inter-RRC node signaling.

### UE-Centric Procedures for Continuation and Stopping of the Threshold/Event-Based RVQoE Reporting

### Periodic (or Subsequent) Threshold Evaluation (PTE)

Upon the value of a metric fulfilling a threshold based criterion to trigger the threshold-based RVQoE reporting (e.g. the value falling below a threshold, or exceeding above the threshold, or being between a first and a second threshold, or being outside a range defined by a first threshold and a second threshold), it is not mandatory/implied to start the RVQoE reporting, unless the condition (event taking place or threshold reached) is met again.

For example, in the case of the Buffer level, the first instance/reporting occurs when the threshold falls below a prescribed level. Then, to avoid excessive RVQoE reporting (e.g. excessive RVQoE periodic reporting), a UE (Application layer) can be configured to wait some time before checking (e.g., waiting period) whether the buffer level is still below the configured threshold.
If the buffer level is below the configured threshold after the waiting period again, the UE may:
   One option: Report the current/second buffer level value and as a response, UE may initiate the RVQoE reporting (e.g. a periodic RVQoE reporting).
   Second option: Report the current/second buffer level value and wait the predefined period of time before checking the buffer level again.
If the buffer level is above the configured threshold after the waiting period:
   The UE does not have to report of the buffer level value.
   There is no need for UE to initiate the RVQoE reporting.
   The periodic (or subsequent) threshold evaluation, e.g., buffer level value with respect to the configured threshold, is still continuously performed every waiting period and, if the buffer value falls below the configured threshold, it is reported as a subsequent buffer level value.

In a particular embodiment, the waiting period is configured to be periodic in time without mandatory reporting of the buffer value if it again/still is above the configured threshold.

In various particular embodiments, the described periodic (or subsequent) threshold evaluation (PTE) may be stopped when:
Option 1: the RVQoE configuration is released,
Option 2: the RVQoE configuration is updated,
Option 3: the UE leaves the session associated with the given RVQoE configuration,
Option 4: the session associated with the given RVQoE configuration stops/ends,
Option 5:
   (a) If the time since the last threshold-based RVQoE report has exceeded some preconfigured maximum waiting period, which does not have to be equal to multiple of waiting period, or
   (b) If the time since the last threshold-based RVQOE report has surpassed a certain number of waiting periods, or
   c) if a timer, associated with the PTE waiting period, expires, e.g., a timer could be configured to expire when the time since the last threshold-based RVQOE reporting, has exceeded a certain period of time,
Option 6: the RVQoE reporting is initiated (e.g. a periodic RVQoE reporting).

In case that the RVQoE reporting was initiated as a result of a threshold condition being fulfilled twice in a row (or multiple times in a row, or multiple times not necessarily in a row) there could be, according to various embodiments, at least three possible actions to stopping it:
Actions related with the PTE:
   Option 1: UE application layer could still be performing PTE
      Stopping the RVQoE reporting immediately: If at any point the metric value is no longer below or above the threshold, depending on the predefined condition for threshold-based trigger, the RVQoE reporting (the periodic RVQoE reporting) is stopped.
      Stopping the RVQoE reporting after a certain time: If the reported value of the metric does not fulfill the predefined threshold-based condition for a certain configured amount of time, which could be the same as:
         maximum waiting period, or
         equal to certain number of multiples of waiting period, or
         expiration time for the timer associated with the PTE waiting period.
   Option 2: PTE is stopped as soon as the RVQoE reporting is initiated (Same as Option 6 in the section above):
      RVQOE reporting (e.g. periodic RVQoE reporting) may continue until:
         The UE is no longer in the session associated with the RVQoE configuration
         The session associated with the RVQoE configuration ends

### Event-Based RVQoE Triggering and Stopping

An occurrence of an event to trigger the RVQoE reporting does not necessarily have to be a single occurrence. According to particular embodiments, he following options may be possible:
Option 1: trigger periodic (or subsequent) threshold evaluation if the threshold-based triggering is configured as a type of event-based triggering as defined in 0.
   This may happen immediately as soon as the first event trigger takes place, or
   If the event trigger takes place a second time (or multiple times) within a predefined waiting period/at the end of the waiting period or other preconfigured time value.
Option 2: trigger event taking place may subsequently trigger RVQoE reporting.
   Once the RVQoE reporting is triggered, it may proceed until:
      The session stops,
      The configuration is released/updated,
      If the RVQoE for the UE is deconfigured.

Stopping the event-based RVQOE reporting may be done when the event that initially triggered reporting does not happen again for a certain preconfigured time

### Possible Unification of the Trigger Types

In some embodiments, threshold-based triggering is merely one type of event-based triggering, and a QoE metric going above or below an associated threshold is seen as an event (alongside events like, for example, handover).

In such embodiments, the same type of event-based RVQoE configuration can be used for all kinds of events, including threshold-based events. Note, however, that some possible configuration parameters or parameter values may only suit threshold-based events while other possible configuration parameters or parameter values may only suite other events, and therefore such non-generically applicable configuration parameters should be optional.

### Combined and Hybrid RVQoE Reporting Trigger Configurations

While threshold-based and event-based triggers are described herein as two different possibilities to configure triggered RVQoE reporting, the concepts described herein do not preclude:
Combining different start criteria that may be based on either one or more RVQoE metric (or the different options describing the possible trigger-based thresholds) satisfying a condition or one or more event-based triggers and a stop criterion that may be based on one or more other RVQOE metrics (or the different options describing the possible trigger-based thresholds) satisfying a condition or one or more other event-based triggers.
Defining a trigger to start reporting that is based on a combination of an event-based trigger together with a threshold-based trigger. The stop criteria for such hybrid triggers may or may not be composed of both the threshold-based and the event-based conditions.
   An example of such a combined condition for starting RVQoE reporting may be that a QoE metric (e.g. a buffer level) is above a threshold and an event (e.g., a handover) occurs (i.e., the event occurs while the RVQoE metric is above the threshold).
As an extension to the above two cases, the above triggers may also be combined with other non-RVQoE/QoE metrics such as radio measurements that may have certain thresholds or events defined on them as pre- or post- or both pre- and post-conditions.

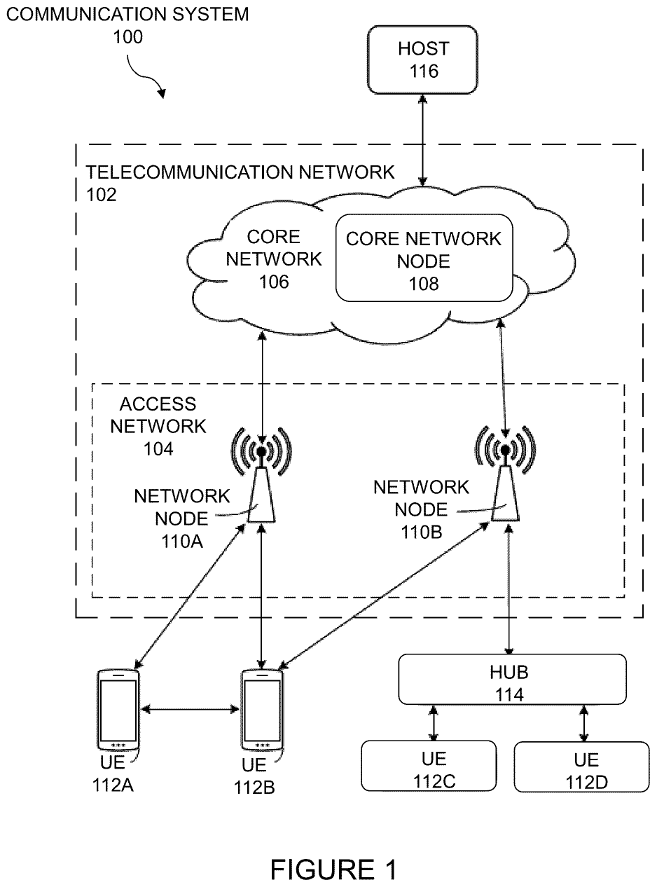

FIG. 1 shows an example of a communication system 100 in accordance with some embodiments. In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3^{rd} Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 1 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110b. In other embodiments, the hub 114 may be a non-dedicated hub—that is, a device which is capable of operating to route communications between the UEs and network node 110b, but which is additionally capable of operating as a communication start and/or end point for certain data channels.

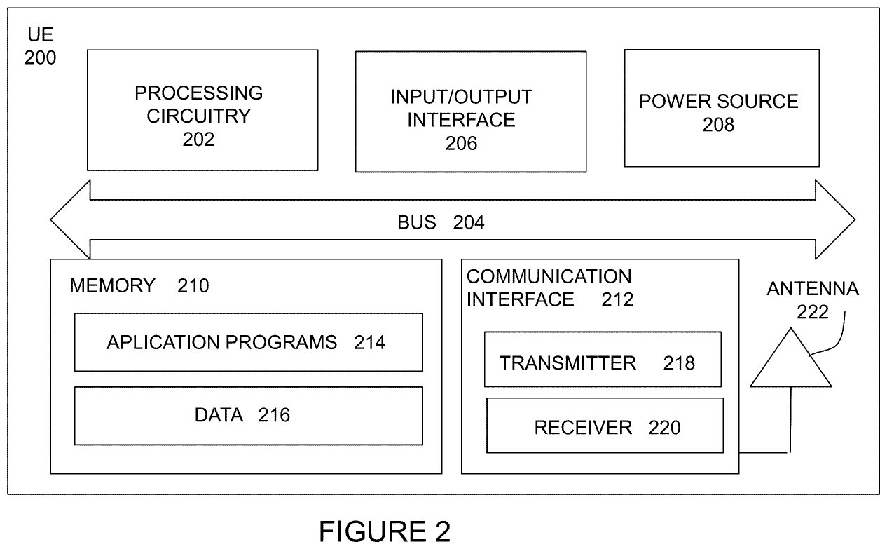

FIG. 2 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 2. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack.

Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 2.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

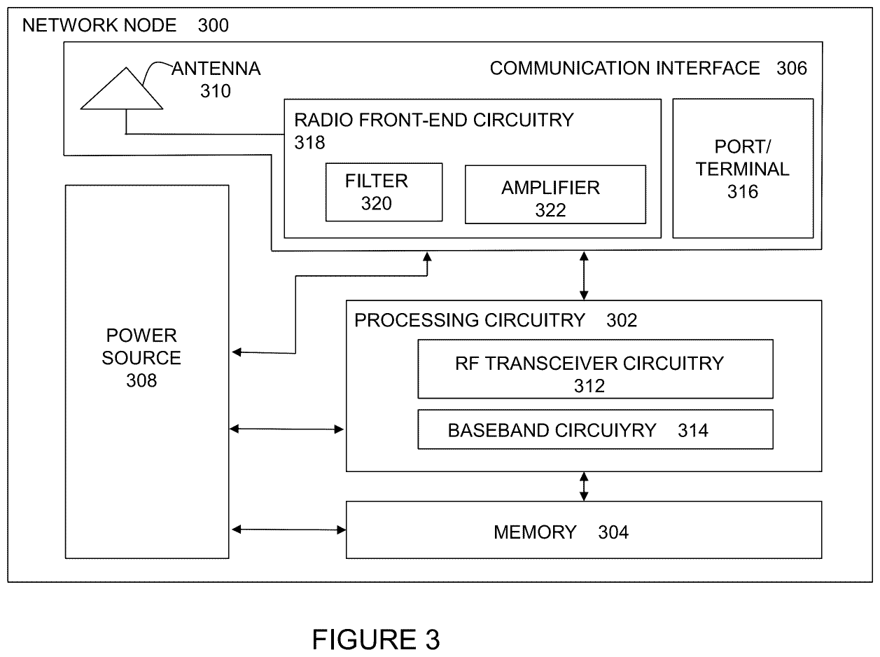

FIG. 3 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (OAM) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 3 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

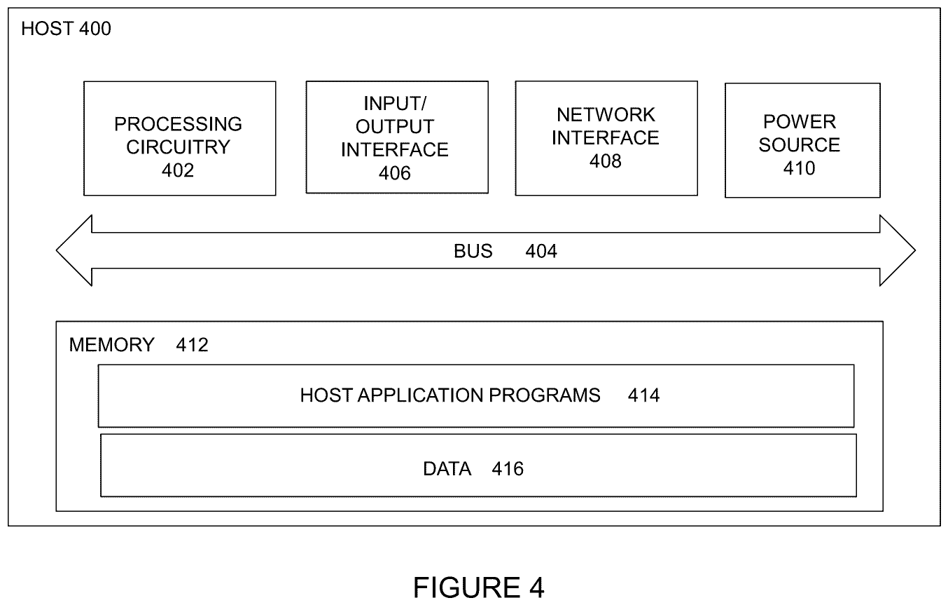

FIG. 4 is a block diagram of a host 400, which may be an embodiment of the host 116 of FIG. 1, in accordance with various aspects described herein.

As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 2 and 3, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

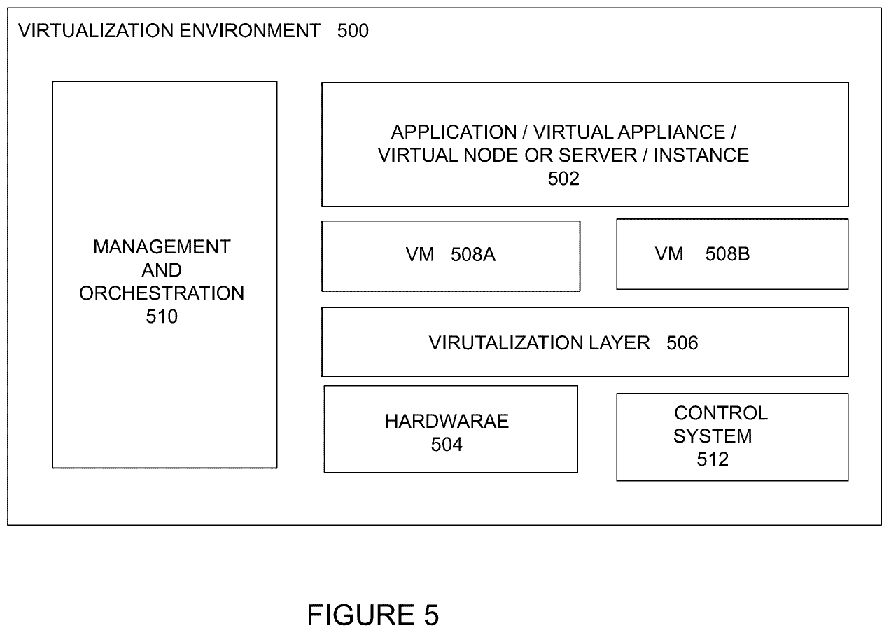

FIG. 5 is a block diagram illustrating a virtualization environment 500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment 500 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein.

The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g. such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

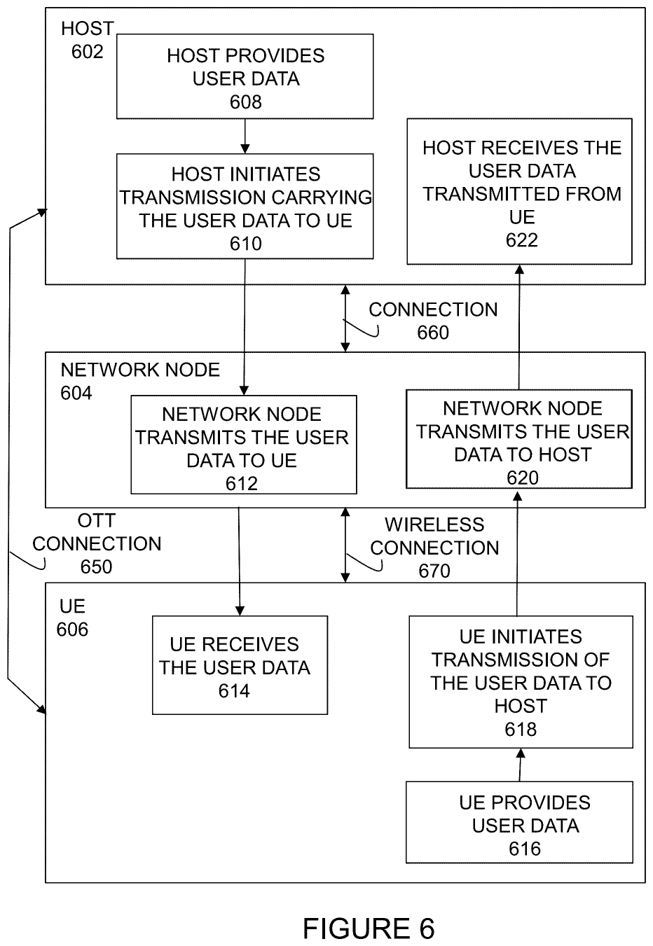

FIG. 6 shows a communication diagram of a host 602 communicating via a network node 604 with a UE 606 over a partially wireless connection in accordance with some embodiments.

Example implementations, in accordance with various embodiments, of the UE (such as a UE 112a of FIG. 1 and/or UE 200 of FIG. 2), network node (such as network node 110a of FIG. 1 and/or network node 300 of FIG. 3), and host (such as host 116 of FIG. 1 and/or host 400 of FIG. 4) discussed in the preceding paragraphs will now be described with reference to FIG. 6.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 1) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve one or more of, for example, data rate, latency, and/or power consumption and, thereby, provide benefits such as, for example, reduced user waiting time, relaxed restriction on file size, improved content resolution, better responsiveness, and/or extended battery lifetime.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes; the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.; the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

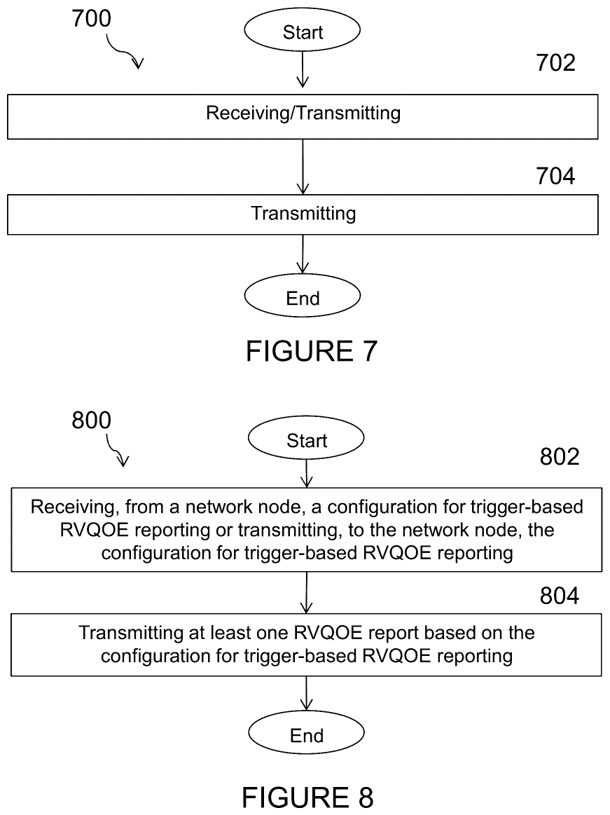

FIG. 7 illustrates an example method 700 by a UE for trigger-based RVQOE reporting, according to certain embodiments. In the illustrated embodiment, the method includes a receiving or transmitting step at 702 and a transmitting step at 704. For example, at step 702, the UE may receive, from a network node, a configuration for trigger-based RVQOE reporting. Alternatively, the UE may transmit, to the network node, the configuration for trigger-based RVQOE reporting.

At step 704, for example, the UE may transmit at least one RVQOE report based on the configuration for trigger-based RVQOE reporting.

FIG. 8 illustrates another example method 800 by a UE 112 for trigger-based RVQOE reporting, according to certain embodiments. As illustrated the method begins at step 802 when the UE 112 receives, from a network node 110, a configuration for trigger-based RVQOE reporting or the UE 112 transmits, to the network node, the configuration for trigger-based RVQOE reporting. At step 804, the UE 112 transmits at least one RVQOE report based on the configuration for trigger-based RVQOE reporting.

In a particular embodiment, the configuration indicates at least one of: at least one first event for triggering transmitting of the RVQOE report to the network node, and at least one second event for triggering the UE to stop transmitting the at least one RVQOE report to the network node.

In a particular embodiment, the UE 112 detects an occurrence of the at least one first event, and the RVQOE report is transmitted based on detecting the occurrence of the event.

In a particular embodiment, when detecting the occurrence of the at least one first event, the UE 112 compares a first value associated with a QoE metric or RVQOE metric to at least a first threshold. The at least one RVQOE report is transmitted when: the first value being below the first threshold, the first value being above the first threshold, or the first value being between a first threshold and a second threshold.

In a particular embodiment, the UE 112 detects the occurrence of the at least one second event and stops transmitting the at least one RRVQOE report based on detecting the occurrence of the at least one second event.

In a particular embodiment, when detecting the occurrence of the at least one second event, the UE 112 compares a second value associated with the QoE metric or RVQOE metric to at least the third threshold. The UE 112 transmits the at least one RVQOE report is stopped when: the second value being below the third threshold, the second value being above the third threshold, or the second value being between the third threshold and a fourth threshold.

In a particular embodiment, at least one of the first value and the second value comprise a buffer level value.

In a particular embodiment, the at least one first and/or second event is detected based on at least one of: receiving an indication from the network node that the at least one first and/or second event has been detected and/or has occurred; detecting that a timer has expired; detecting that at least one condition associated with a radio layer has been fulfilled; and detecting that at least one condition associated with an application layer has been fulfilled.

In a particular embodiment, the configuration includes at least one of: an indication to send the at least one RVQOE report; an indication of when to start sending the at least one RVQOE report; an indication of a time period for sending the at least one RVQOE report; and an indication to send the at least one RVQOE report with or as part of at least one of: a Radio Link Failure report, a Random Access report, a Successful Handover report, a Successful Primary Secondary Cell Change or Addition report, and a Connection Establishment Failure report; and an indication of when to stop sending the at least one RVQOE report.

In a particular embodiment, the indication to start sending RVQOE reports includes an indication to start sending the at least one RVQOE report when: a first value of at least one RVQoE metric is above a first threshold, a first value of at least one RVQoE metric is below a first threshold, a first value of at least one RVQoE metric is between a first threshold and a second threshold, or a first value of at least one RVQoE metric is outside a range comprised between a first threshold and a second threshold.

In another particular embodiment, the indication to start sending RVQOE reports includes an indication to start sending the at least one RVQOE report when: a first value of at least one RVQOE metric is below a first threshold, a first value of at least one RVQoE metric is above a first threshold, a first value of at least one RVQOE metric is between a first threshold and a second threshold, or a first value of at least one RVQoE metric is outside a range comprised between a first threshold and a second threshold.

In a particular embodiment, the indication of when to stop sending the at least one RVQOE report comprises an indication to stop sending the at least one RVQOE report when: a second value of at least one RVQoE metric is above a third threshold; a second value of at least one RVQoE metric is below a third threshold; a second value of at least one RVQoE metric is between a third threshold and a fourth threshold; or a value of a buffer level value is above a threshold. In another particular embodiment, the indication of when to stop sending the at least one RVQOE report comprises an indication to stop sending the at least one RVQOE report when: a second value of at least one RVQoE metric is below a third threshold; a second value of at least one RVQOE metric is above a third threshold; a second value of at least one RVQoE metric is between a third threshold and a fourth threshold; or a value of a buffer level value is above a threshold.

In a particular embodiment, the configuration includes an indication to send the at least one RVQOE report from an application layer of the UE 112 to a radio layer of the UE 112, and the UE 112 transmits the at least one RVQOE report from the application layer of the UE to the radio layer of the UE.

In a particular embodiment, the configuration includes an indication to send the at least one RVQOE report from a radio layer of the UE 112 to the network node 110, and the UE 112 transmits the at least one RVQOE report from the radio layer of the UE 112 to the network node 110.

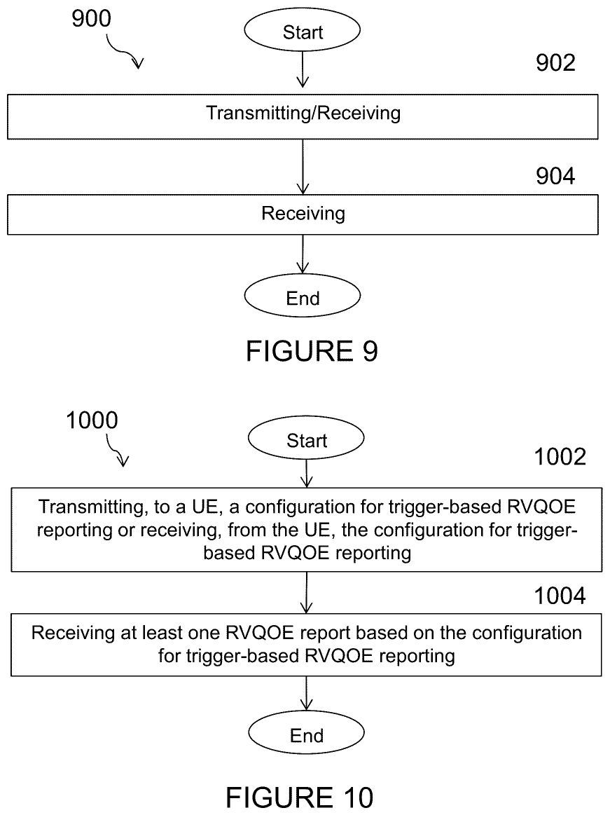

FIG. 9 illustrates an example method 900 by a network node 110 for trigger-based RVQOE reporting, according to certain embodiments. In the illustrated embodiment, the method includes a transmitting or receiving step at 902 and a receiving step at 904. For example, at step 902, the network node 110 may transmit, to a UE 112, a configuration for trigger-based RVQOE reporting. Alternatively, the network node 110 may receive, from the UE 112, the configuration for trigger-based RVQOE reporting. At step 904, for example, the network node 110 may receive at least one RVQOE report based on the configuration for trigger-based RVQOE reporting.

FIG. 10 illustrates another example method 1000 by a network node 110 for trigger-based RVQOE reporting, according to certain embodiments. As illustrated the method begins at step 1002 when network node 110 transmits, to UE 112, a configuration for trigger-based RVQOE reporting or the network node 110 receives, from the UE 112, the configuration for trigger-based RVQOE reporting. At step 1004, the network node 110 receives at least one RVQOE report based on the configuration for trigger-based RVQOE reporting.

In a particular embodiment, the configuration indicates at least one of: at least one first event for triggering the UE 112 to transmit the at least one RVQOE report to the network node 110, and/or at least one second event for triggering 112 the UE to stop transmitting the at least one RVQOE report to the network node 110.

In a particular embodiment, the network node 110 configures the UE 112 to perform at least one of: detecting an occurrence of the at least one first event and transmit the at least one RVQOE report to the network node 110 based on detecting the occurrence of the at least one event, and/or detecting an occurrence of the at least one second event and stop transmitting the at least one RVQOE report based on detecting the occurrence of the at least one second event.

In a particular embodiment, when configuring the UE 112 to detect the occurrence of the at least one first event, the network node 110 configures UE 112 to: compare a first value associated with a QoE metric or RVQOE metric to at least a first threshold, and transmit the at least one RVQOE report when: the first value is below the first threshold, the first value is above the first threshold, or the first value is between the first threshold and a second threshold.

In a particular embodiment, when configuring the UE 112 to detect the occurrence of the at least one second event, the network node 110 configures the UE 112 to: compare a second value associated with a QoE metric or RVQOE metric to at least a third threshold, and stop transmitting the at least one RVQOE report when: the second value is below the third threshold, the second value is above the third threshold, or the second value is between the third threshold and a fourth threshold.

In a particular embodiment, at least one of the first value and the second value comprises a buffer level value.

In a particular embodiment, when configuring the UE 112 to detect the at least one first event and/or second event, the network node 110 configures the UE 112 to detect the first and/or second event based on at least one of: receiving an indication from the network node 110 that indicates the at least one first and/or second event has been detected and/or has occurred; detecting that a timer has expired; detecting that at least one condition associated with a radio layer has been fulfilled; and detecting that at least one condition associated with an application layer has been fulfilled.

In a particular embodiment, the configuration comprises at least one of: an indication to send the at least one RVQOE report; an indication of when to start sending the at least one RVQOE report; an indication of a time period for sending the at least one RVQOE report; an indication to send the at least one RVQOE report with or as part of at least one of: a Radio Link Failure report, a Random Access report, a Successful Handover report, a Successful Primary Secondary Cell Change or Addition report, and a Connection Establishment Failure report; and/or an indication of when to stop sending the at least one RVQOE report.

In a particular embodiment, the indication to start sending RVQOE reports includes an indication to start sending the at least one RVQOE report when: a first value of at least one RVQoE metric is above a first threshold; a first value of at least one RVQoE metric is below a first threshold; a first value of at least one RVQoE metric is between a first threshold and a second threshold; or a first value of at least one RVQoE metric is outside a range comprised between a first threshold and a second threshold.

In another particular embodiment, the indication to start sending RVQOE reports includes an indication to start sending the at least one RVQOE report when: a first value of at least one RVQoE metric is below a first threshold; a first value of at least one RVQOE metric is above a first threshold; a first value of at least one RVQoE metric is between a first threshold and a second threshold; or a first value of at least one RVQoE metric is outside a range comprised between a first threshold and a second threshold.

In a particular embodiment, the indication to stop sending the at least one RVQOE report comprises an indication to stop sending the at least one RVQOE report when: a second value of at least one RVQoE metric is above a third threshold; a second value of at least one RVQoE metric is below a third threshold; a second value of at least one RVQoE metric is between a third threshold and a fourth threshold; or a value of a buffer level value is above a threshold.

In another particular embodiment, the indication to stop sending the at least one RVQOE report comprises an indication to stop sending the at least one RVQOE report when: a second value of at least one RVQoE metric is below a third threshold; a second value of at least one RVQoE metric is above a third threshold; a second value of at least one RVQoE metric is between a third threshold and a fourth threshold; or a value of a buffer level value is above a threshold.

In a particular embodiment, in the configuration comprises an indication to send the at least one RVQOE report from an application layer of the UE 112 to a radio layer of the UE 112.

In a particular embodiment, the configuration comprises an indication to send the at least one RVQOE report from a radio layer of the UE 112 to the network node 110.

In a particular embodiment, the network node 110 receives the configuration from another network node and/or transmits the configuration to another network node.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EXAMPLE EMBODIMENTS

### Group A Example Embodiments

Example Embodiment A1. A method by a user equipment for trigger-based RVQOE reporting, the method comprising: any of the user equipment steps, features, or functions described above, either alone or in combination with other steps, features, or functions described above.

Example Embodiment A2. The method of the previous embodiment, further comprising one or more additional user equipment steps, features or functions described above.

Example Embodiment A3. The method of any of the previous embodiments, further comprising: providing user data; and forwarding the user data to a host computer via the transmission to the network node.

### Group B Example Embodiments

Example Embodiment B1. A method performed by a network node for trigger-based RVQOE reporting, the method comprising: any of the network node steps, features, or functions described above, either alone or in combination with other steps, features, or functions described above.

Example Embodiment B2. The method of the previous embodiment, further comprising one or more additional network node steps, features or functions described above.

Example Embodiment B3. The method of any of the previous embodiments, further comprising: obtaining user data; and forwarding the user data to a host or a user equipment.

### Group C Example Embodiments

Example Embodiment C1. A method by a user equipment (UE) for trigger-based RAN-visible Quality of Experience (RVQOE) reporting, the method comprising at least one of: receiving, from a network node, a configuration for trigger-based RVQOE reporting or transmitting, to the network node, the configuration for trigger-based RVQOE reporting; and transmitting at least one RVQOE report based on the configuration for trigger-based RVQOE reporting.

Example Embodiment C2. The method of Example Embodiment C1, wherein the configuration indicates at least one event and/or threshold for triggering the transmitting of the RVOE report, wherein the at least one RVQOE report is transmitted to the network node based on detection of the at least one event and/or threshold.

Example Embodiment C3. The method of Example Embodiment C2, comprising at least one of: detecting an occurrence of the at least one event, and/or comparing at least one value associated with a QoE or RVQOE Metric to at least one threshold, and wherein the RVQOE report is transmitted to the network based on detecting the occurrence of the event and/or comparing the measurement value to the threshold.

Example Embodiment C4. The method of any one of Example Embodiments C2 to C3, wherein the at least one event is detected based on at least one of: receiving an indication from the network node that the at least one event has been detected and/or has occurred; detecting that a timer has expired; detecting that at least one entering condition associated with a radio measurement is fulfilled; detecting that at least one exiting condition associated with a radio measurement is fulfilled; detecting an alignment and/or correlation between at least one radio measurement and at least one QoE and/or RVQOE measurement; detecting that a buffer level value is below a threshold; detecting that the UE has transitioned from dual connectivity to single connectivity; detecting that the UE has transitioned from single connectivity to dual connectivity; detecting that the UE has been configured for MRB; detecting that the UE has been configured for DRB; detecting a transition of a radio layer of the UE from one RRC state to another RRC state; detecting a transition of a radio layer of the UE from a non-RRC connected state to a RRC connected state; detecting a transition of a radio layer of the UE from a RRC connected state to a non-RRC connected state; detecting an overload condition being fulfilled; detecting a handover or mobility procedure being performed; detecting that the UE has moved from a first cell to a second cell; detecting a radio link failure; detecting a random access failure; performing a RRC reestablishment; performing a RRC resume; and detecting that the UE has entered a geographical area, a PLMN, and/or a TA.

Example Embodiment C5. The method of any one of Example Embodiments C2 to C4, wherein transmitting the at least one RVQOE report based on detection of the at least one event and/or threshold comprises: transmitting a single RVQOE report.

Example Embodiment C6. The method of any one of Example Embodiments C2 to C4, wherein transmitting the at least one RVQOE report based on detection of the at least one event and/or threshold comprises: transmitting a plurality of RVQOE reports.

Example Embodiment C7. The method of any one of Example Embodiments C1 to C6, wherein the configuration comprise at least one of: an indication of a number of RVQOE reports to be transmitted; an indication that the at least one RVQOE report is to be sent periodically; an indication for deriving a periodicity for transmitting the at least one RVQOE report; an indication of a periodicity for transmitting the at least one RVQOE report; an indication to send the at least one RVQOE report; an indication to start sending RVQOE reports; an indication of a time period for sending the at least one RVQOE report; an indication of at least one RVQOE metric to which the configuration applies; an indication to collect at least one RVQOE metric for the at least one RVQOE report; an indication of a time when the at least one RVQOE report is required to be transmitted; an indication for starting and/or stopping a timer; an indication to monitor for an expiration of a timer; an indication to send the at least one RVQOE report with or as part of at least one of: a RLF report, a RA report, a SHR, a SPR, and a CEF; an indication of an event for determining that the configuration is invalid and/or to be discarded; an indication of when to stop sending RVQOE reports; an indication to stop sending the at least one RVQOE report when the UE moves from a first cell to a second cell; an indication of when to pause sending RVQOE reports; and an indication of when to resume sending RVQOE reports.

Example Embodiment C8. The method of Example Embodiment C7, wherein the indication to start sending RVQOE reports comprises an indication to start sending the at least one RVQOE report when at least one of: a value of at least one or at least more than one RVQoE metric is above a threshold, a value of at least one or at least more than one RVQoE metric is below a threshold, a value of at least one or at least more than one RVQoE metric is between a first threshold and a second threshold, a value of at least one RVQOE metric is outside a range comprised between a first threshold and a second threshold, any of the above, but with the RVQoE metric replaced by an average of a set of sampled values of the RVQOE metric (i.e. a set of samples): an average of a certain number of samples, a weighted average of a certain number of samples, an average of the samples, a weighted average of a certain number of samples, a sliding average, an exponential average; any of the above, but with the RVQoE metric replaced by the time derivative (or the second, third or N^{th} time derivative) of the RVQoE metric; a value fulfilling any of the above for a TTT (time-to-trigger) duration of time; a value of a function whose value is derived based on at least one or at least more than one RVQoE metric is above or below a threshold, a value of a function as a property of the time-series of at least one or at least more than one RVQOE metric, for e.g., slope of metric satisfies a threshold for a certain time-period or number of samples, a value of a metric or a function applied to one or more metrics (where the metrics in this case are not RVQOE metrics but other metrics that are accessible at the application or the AS) is above or below a threshold; and any of the above where the conditional sending of RVQoE reports (e.g. to start sending based on a condition) is replaced by conditional logging of RVQoE measurement results.

Example Embodiment C9. The method of Example Embodiment C8, comprising detecting at least one occurrence of any of the events associated with the indications of Example Embodiment C8.

Example Embodiment C10. The method of any one of Example Embodiments C7 to C9, wherein the indication to stop sending RVQOE reports comprises an indication to stop sending the at least one RVQOE report when at least one of: a value of at least one RVQoE metric is above a threshold; ae value of at least one RVQoE metric is below a threshold; a value of at least one RVQOE metric is between a first threshold and a second threshold; a value of a buffer level value is above a threshold; a value of at least one RVQoE metric is outside a range comprised between a first threshold and a second threshold; any of the above, but with the RVQoE metric replaced by an average of a set of sampled values of the RVQoE metric (i.e. a set of samples): an average of a certain number of samples, a weighted average of a certain number of samples, an average of the samples, a weighted average of a certain number of samples, a sliding average, an exponential average; any of the above, but with the RVQOE metric replaced by the time derivative (or the second, third or N^{th} time derivative) of the RVQoE metric; a value being outside the range for a TTT (time-to-trigger) duration of time; a value of a function whose value is derived based on at least one or at least more than one RVQoE metric is above or below a threshold; a value of a function as a property of the time-series of at least one or at least more than one RVQOE metric, for e.g., slope of metric satisfies a threshold for a certain time-period or number of samples: the trend of at least one or at least more than one RVQoE metric follows a certain pattern, a value of a metric or a function applied to one or more metrics (where the metrics in this case are not RVQoE metrics but other metrics that are accessible at the application or the AS) is above or below a threshold; and any of the above where the conditional stopping of RVQoE reporting (e.g. to stop based on a condition) is replaced by conditional stopping of logging of RVQoE measurement results.

Example Embodiment C11. The method of Example Embodiment C10, comprising detecting at least one occurrence of any of the events associated with the indications of Example Embodiment C10.

Example Embodiment C12. The method of any one of Example Embodiments C2 to C11, wherein detecting the occurrence of the at least one event comprises detecting that a buffer level value is below a first threshold, wherein the at least one RVQOE report is transmitted based on the buffer level value being below the first threshold, and wherein the method, optionally, further comprises: detecting that the buffer level is above a second threshold and stopping transmitting the at least one RVQOE report when the buffer level is above the second threshold.

Example Embodiment C13. The method of any one of Example Embodiments C2 to C11, wherein detecting the occurrence of the at least one event comprises detecting that a buffer level value is below a first threshold, wherein the at least one RVQOE report is transmitted based on the buffer level value being below the first threshold, and wherein the method, optionally, further comprises: detecting that the buffer level is above a second threshold, transmit N number of RVQOE reports after the buffer level is above the second threshold, and stopping transmitting the at least one RVQOE report after transmitting the N number of RVQOE reports.

Example Embodiment C14. The method of any one of Example Embodiments C2 to C11, wherein detecting the occurrence of the at least one event comprises detecting that a buffer level value is below a first threshold, wherein the at least one RVQOE report is transmitted based on the buffer level value being below the first threshold, and wherein the instructions comprise an indication that the UE is transmit N number of RVQOE reports after detecting that the buffer level value is below the first threshold.

Example Embodiment C15. The method of any one of Example Embodiments C1 to C14, wherein: the configuration comprises an indication to send the at least one RVQOE report from an application layer of the UE to a radio layer of the UE (i.e., an UE Access Stratum); and transmitting the at least one RVQOE report comprises transmitting the at least one RVQOE report from the application layer of the UE to the radio layer of the UE.

Example Embodiment C16. The method of any one of Example Embodiments C1 to C15, wherein: the configuration comprises an indication to send the at least one RVQOE report from a radio layer of the UE to a network node; and transmitting the at least one RVQOE report comprises transmitting the at least one RVQOE report from the radio layer of the UE to the network node.

Example Embodiment C17. The method of any one of Example Embodiments C1 to C16, wherein receiving the at least one configuration comprises receiving the configuration with a RVQOE measurement configuration.

Example Embodiment C18. The method of any one of Example Embodiments C1 to C16, comprising receiving a RVQOE measurement configuration, and wherein the at least one configuration is received separately from the RVQOE measurement configuration.

Example Embodiment C19. The method of any one of Example Embodiments C1 to C18, wherein: the configuration indicate at least one condition to be monitored for and/or fulfilled for triggering the transmitting of the RVOE report, the method comprises determining that the at least one condition has been fulfilled, and the RVQOE report is transmitted to the network based on the condition being fulfilled.

Example Embodiment C20. The method of Example Embodiment C19, wherein the at least one condition comprises any one of the event-based or trigger-based events described herein.

Example Embodiment C21. The method of Example Embodiments C1 to C20, further comprising: providing user data; and forwarding the user data to a host via the transmission to the network node.

Example Embodiment C22. A user equipment comprising processing circuitry configured to perform any of the methods of Example Embodiments C1 to C21.

Example Embodiment C23. A user equipment configured to perform any of the methods of Example Embodiments C1 to C21.

Example Embodiment C24. A wireless device comprising processing circuitry configured to perform any of the methods of Example Embodiments C1 to C21.

Example Embodiment C25. A computer program comprising instructions which when executed on a computer perform any of the methods of Example Embodiments C1 to C21.

Example Embodiment C26. A computer program product comprising computer program, the computer program comprising instructions which when executed on a computer perform any of the methods of Example Embodiments C1 to C21.

Example Embodiment C27. A non-transitory computer readable medium storing instructions which when executed by a computer perform any of the methods of Example Embodiments C1 to C21.

### Group D Example Embodiments

Example Embodiment D1. A method by a network node for trigger-based RVQOE reporting, the method comprising at least one of: transmitting, to a user equipment (UE), a configuration for trigger-based RVQOE reporting or receiving, from the UE, the configuration for trigger-based RVQOE reporting; and receiving at least one RVQOE report based on the configuration for trigger-based RVQOE reporting.

Example Embodiment D2. The method of Example Embodiment D1, wherein the configuration indicates at least one event and/or threshold for triggering the UE to transmit the at least one RVOE report to the network node.

Example Embodiment D3. The method of Example Embodiment D3, comprising configuring the UE to perform at least one of: detecting an occurrence of the at least one event and/or comparing at least one value associated with a QoE or RVQOE Metric to at least one threshold, and transmitting the at least one RVQOE report to the network node based on detecting the occurrence of the event and/or comparing the measurement value to the threshold.

Example Embodiment D4. The method of any one of Example Embodiments D2 to D3, comprising configuring the UE to detect the at least one event based on at least one of: receiving an indication from the network node that indicates the at least one event has been detected and/or has occurred; a timer expiring; at least one entering condition associated with a radio measurement being fulfilled; detecting that at least one exiting condition associated with a radio measurement is fulfilled; detecting an alignment and/or correlation between at least one radio measurement and at least one QoE and/or RVQOE measurement; detecting that a buffer level value is below a threshold; detecting that the UE has transitioned from dual connectivity to single connectivity; detecting that the UE has transitioned from single connectivity to dual connectivity; detecting that the UE has been configured for MRB; detecting that the UE has been configured for DRB; detecting a transition of a radio layer of the UE from one RRC state to another RRC state; detecting a transition of a radio layer of the UE from a non-RRC connected state to a RRC connected state; detecting a transition of a radio layer of the UE from a RRC connected state to a non-RRC connected state; detecting an overload condition being fulfilled; detecting a handover or mobility procedure being performed; detecting that the UE has moved from a first cell to a second cell; detecting a radio link failure; detecting a random access failure; performing a RRC reestablishment; performing a RRC resume; and detecting that the UE has entered a geographical area, a PLMN, and/or a TA.

Example Embodiment D5. The method of any one of Example Embodiments D2 to D4, wherein receiving the at least one RVQOE report comprises receiving a single RVQOE report.

Example Embodiment D6. The method of any one of Example Embodiments D2 to D4, wherein receiving the at least one RVQOE report comprises receiving a plurality of RVQOE reports.

Example Embodiment D7. The method of any one of Example Embodiments D1 to D6, wherein the configuration comprises at least one of: an indication of a number of RVQOE reports to be transmitted by the UE; an indication that the at least one RVQOE report is to be sent periodically; an indication that the UE is to derive a periodicity for transmitting the at least one RVQOE report; an indication of a periodicity for transmitting the at least one RVQOE report; an indication to send the at least one RVQOE report; an indication to start sending RVQOE reports; an indication of a time period for sending the at least one RVQOE report; an indication of at least one RVQOE metric to which the configuration applies; an indication to collect at least one RVQOE metric for the at least one RVQOE report; an indication of a time when the at least one RVQOE report is required to be transmitted; an indication for starting and/or stopping a timer; an indication to monitor for an expiration of a timer; an indication to send the at least one RVQOE report with or as part of at least one of: a RLF report, a RA report, a SHR, a SPR, and a CEF; an indication of an event for determining that the configuration is invalid and/or to be discarded; an indication of when to stop sending RVQOE reports; an indication to stop sending the at least one RVQOE report when the UE moves from a first cell to a second cell; an indication of when to pause sending RVQOE reports; and an indication of when to resume sending RVQOE reports.

Example Embodiment D8. The method of Example Embodiment D7, wherein the indication to start sending RVQOE reports comprises an indication to start sending the at least one RVQOE report when at least one of: a value of at least one or at least more than one RVQoE metric is above a threshold, a value of at least one or at least more than one RVQoE metric is below a threshold, a value of at least one or at least more than one RVQoE metric is between a first threshold and a second threshold, a value of at least one RVQoE metric is outside a range comprised between a first threshold and a second threshold, any of the above, but with the RVQoE metric replaced by an average of a set of sampled values of the RVQoE metric (i.e. a set of samples) such as an average of a certain number of samples, a weighted average of a certain number of samples, an average of the samples, a weighted average of a certain number of samples, a sliding average, an exponential average, any of the above, but with the RVQoE metric replaced by the time derivative (or the second, third or N^{th} time derivative) of the RVQoE metric; a value fulfilling any of the above for a TTT (time-to-trigger) duration of time; a value of a function whose value is derived based on at least one or at least more than one RVQoE metric is above or below a threshold; a value of a function as a property of the time-series of at least one or at least more than one RVQoE metric, for e.g., slope of metric satisfies a threshold for a certain time-period or number of samples: a value of a metric or a function applied to one or more metrics (where the metrics in this case are not RVQOE metrics but other metrics that are accessible at the application or the AS) is above or below a threshold; and any of the above where the conditional sending of RVQoE reports (e.g. to start sending based on a condition) is replaced by conditional logging of RVQoE measurement results.

Example Embodiment D9. The method of Example Embodiment D8, comprising configuring the UE to detect at least one occurrence of any of the events associated with the indications of Example Embodiment D8.

Example Embodiment D10. The method of any one of Example Embodiments D7 to D9, wherein the indication to stop sending RVQOE reports comprises an indication to stop sending the at least one RVQOE report when at least one of: a value of at least one RVQoE metric is above a threshold; a value of at least one RVQoE metric is below a threshold; a value of at least one RVQOE metric is between a first threshold and a second threshold; a value of a buffer level value is above a threshold; a value of at least one RVQoE metric is outside a range comprised between a first threshold and a second threshold; any of the above, but with the RVQOE metric replaced by an average of a set of sampled values of the RVQoE metric (i.e. a set of samples) such as an average of a certain number of samples, a weighted average of a certain number of samples, an average of the samples, a weighted average of a certain number of samples, a sliding average, an exponential average; any of the above, but with the RVQoE metric replaced by the time derivative (or the second, third or N^{th} time derivative) of the RVQoE metric such as a value being outside the range for a TTT (time-to-trigger) duration of time; a value of a function whose value is derived based on at least one or at least more than one RVQoE metric is above or below a threshold; a value of a function as a property of the time-series of at least one or at least more than one RVQoE metric, for e.g., slope of metric satisfies a threshold for a certain time-period or number of samples (the trend of at least one or at least more than one RVQoE metric follows a certain pattern); a value of a metric or a function applied to one or more metrics (where the metrics in this case are not RVQOE metrics but other metrics that are accessible at the application or the AS) is above or below a threshold; and any of the above where the conditional stopping of RVQoE reporting (e.g. to stop based on a condition) is replaced by conditional stopping of logging of RVQoE measurement results.

Example Embodiment D11. The method of Example Embodiment D10, comprising configuring the UE to detect at least one occurrence of any of the events associated with the indications of Example Embodiment D10.

Example Embodiment D12. The method of any one of Example Embodiments D2 to D11, wherein configuring the UE to detect the occurrence of the at least one event comprises configuring the UE to detect when a buffer level value is below a first threshold, wherein the at least one RVQOE report is transmitted by the UE based on the buffer level value being below the first threshold, and wherein the method, optionally, further comprises: configuring the UE to detect when the buffer level is above a second threshold and stopping transmitting the at least one RVQOE report when the buffer level is above the second threshold.

Example Embodiment D13. The method of any one of Example Embodiments D2 to D11, wherein configuring the UE to detect the occurrence of the at least one event comprises configuring the UE to detect that a buffer level value is below a first threshold, wherein the at least one RVQOE report is transmitted by the UE based on the buffer level value being below the first threshold, and wherein the method, optionally, further comprises configuring the UE to: detect that the buffer level is above a second threshold, transmit N number of RVQOE reports after the buffer level is above the second threshold, and stop transmitting the at least one RVQOE report after transmitting the N number of RVQOE reports.

Example Embodiment D14. The method of any one of Example Embodiments D2 to D11, wherein configuring the UE to detect the occurrence of the at least one event comprises configuring the UE to detect that a buffer level value is below a first threshold, wherein the at least one RVQOE report is transmitted by the UE based on the buffer level value being below the first threshold, and wherein the instructions comprise an indication that the UE is transmit N number of RVQOE reports after detecting that the buffer level value is below the first threshold.

Example Embodiment D15. The method of any one of Example Embodiments D1 to D14, wherein the configuration comprises an indication to send the at least one RVQOE report from an application layer of the UE to a radio layer of the UE (i.e., an UE Access Stratum).

Example Embodiment D16. The method of any one of Example Embodiments C1 to C15, wherein: the configuration comprises an indication to send the at least one RVQOE report from a radio layer of the UE to a network node; and receiving the at least one RVQOE report comprises receiving the at least one RVQOE report from the radio layer of the UE.

Example Embodiment D17. The method of any one of Example Embodiments D1 to D16, wherein transmitting the at least one configuration comprises transmitting the configuration with a RVQOE measurement configuration.

Example Embodiment D18. The method of any one of Example Embodiments D1 to D16, comprising transmitting a RVQOE measurement configuration, and wherein the at least one configuration is transmitted separately from the RVQOE measurement configuration.

Example Embodiment D19. The method of any one of Example Embodiments D1 to D18, wherein: the configuration indicate at least one condition to be monitored for and/or fulfilled for triggering the transmitting of the RVOE report, the method comprises configuring the UE to determine that the at least one condition has been fulfilled, and the RVQOE report is received from the UE based on the condition being fulfilled.

Example Embodiment D20. The method of Example Embodiment D19, wherein the at least one condition comprises any one of the event-based or trigger-based events described herein.

Example Embodiment D21. The method of any one of Example Embodiments D1 to D20, wherein transmitting the configuration comprises transmitting the configuration as part of at least one of: an RRC Reconfiguration procedure; an RRC Setup procedure; an RRC connection establishment procedure; an RRCSetup message; an RRCRestablishment message; and an RRCReconfiguration message.

Example Embodiment D22. The method of any one of Example Embodiments D1 to D21, wherein the configuration is received from the UE as part of at least one of: an RRC UE Information procedure; an RRC Setup procedure; an RRC connection resume procedure; an RRC Connection reestablishment procedure; an RRC UEInformationResponse message; an an message; RRCResumeComplete message; RRCSetupComplete and an RRCReestablishmentComplete message.

Example Embodiment D23. The method of any one of Example Embodiments D1 to D22, comprising at least one of: receiving the configuration from another network node; and transmitting the configuration to another network node.

Example Embodiment D24. The method of any one of Example Embodiments D1 to D23, wherein the network node comprises a gNodeB (gNB).

Example Embodiment D25. The method of any of the previous Example Embodiments, further comprising: obtaining user data; and forwarding the user data to a host or a user equipment.

Example Embodiment D26. A network node comprising processing circuitry configured to perform any of the methods of Example Embodiments D1 to D25.

Example Embodiment D27. A network node configured to perform any of the methods of Example Embodiments D1 to D25.

Example Embodiment D28. A computer program comprising instructions which when executed on a computer perform any of the methods of Example Embodiments D1 to D25.

Example Embodiment D29. A computer program product comprising computer program, the computer program comprising instructions which when executed on a computer perform any of the methods of Example Embodiments D1 to D25.

Example Embodiment D30. A non-transitory computer readable medium storing instructions which when executed by a computer perform any of the methods of Example Embodiments D1 to D25.

### Group E Example Embodiments

Example Embodiment E1. A user equipment for trigger-based RVQOE reporting, the UE comprising: processing circuitry configured to perform any of the steps of any of the Group A and C Example Embodiments; and power supply circuitry configured to supply power to the processing circuitry.

Example Embodiment E2. A network node for trigger-based RVQOE reporting, the network node comprising: processing circuitry configured to perform any of the steps of any of the Group B and D Example Embodiments; power supply circuitry configured to supply power to the processing circuitry.

Example Embodiment E3. A user equipment (UE) for trigger-based RVQOE reporting, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A and C Example Embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Example Embodiment E4. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to receive the user data from the host.

Example Embodiment E5. The host of the previous Example Embodiment, wherein the cellular network further includes a network node configured to communicate with the UE to transmit the user data to the UE from the host.

Example Embodiment E6. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E7. A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Example Embodiment E8. The method of the previous Example Embodiment, further comprising: at the host, executing a host application associated with a client application executing on the UE to receive the user data from the UE.

Example Embodiment E9. The method of the previous Example Embodiment, further comprising: at the host, transmitting input data to the client application executing on the UE, the input data being provided by executing the host application, wherein the user data is provided by the client application in response to the input data from the host application.

Example Embodiment E10. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to transmit the user data to the host.

Example Embodiment E11. The host of the previous Example Embodiment, wherein the cellular network further includes a network node configured to communicate with the UE to transmit the user data from the UE to the host.

Example Embodiment E12. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E13. A method implemented by a host configured to operate in a communication system that further includes a network node and a user equipment (UE), the method comprising: at the host, receiving user data transmitted to the host via the network node by the UE, wherein the UE performs any of the steps of any of the Group A and C Example Embodiments to transmit the user data to the host.

Example Embodiment E14. The method of the previous Example Embodiment, further comprising: at the host, executing a host application associated with a client application executing on the UE to receive the user data from the UE.

Example Embodiment E15. The method of the previous Example Embodiment, further comprising: at the host, transmitting input data to the client application executing on the UE, the input data being provided by executing the host application, wherein the user data is provided by the client application in response to the input data from the host application.

Example Embodiment E16. A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B and D Example Embodiments to transmit the user data from the host to the UE.

Example Embodiment E17. The host of the previous Example Embodiment, wherein: the processing circuitry of the host is configured to execute a host application that provides the user data; and the UE comprises processing circuitry configured to execute a client application associated with the host application to receive the transmission of user data from the host.

Example Embodiment E18. A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B and D Example Embodiments to transmit the user data from the host to the UE.

Example Embodiment E19. The method of the previous Example Embodiment, further comprising, at the network node, transmitting the user data provided by the host for the UE.

Example Embodiment E20. The method of any of the previous 2 Example Embodiments, wherein the user data is provided at the host by executing a host application that interacts with a client application executing on the UE, the client application being associated with the host application.

Example Embodiment E21. A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B and D Example Embodiments to transmit the user data from the host to the UE.

Example Embodiment E22. The communication system of the previous Example Embodiment, further comprising: the network node; and/or the user equipment.

Example Embodiment E23. A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B and D Example Embodiments to receive the user data from a user equipment (UE) for the host.

Example Embodiment E24. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E25. The host of the any of the previous 2 Example Embodiments, wherein the initiating receipt of the user data comprises requesting the user data.

Example Embodiment E26. A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B and D Example Embodiments to receive the user data from the UE for the host.

Example Embodiment E27. The method of the previous Example Embodiment, further comprising at the network node, transmitting the received user data to the host.

1. A method by a user equipment, UE, for trigger-based Radio Access Network-Visible Quality of Experience, RVQOE, reporting, the method comprising:
receiving, from a network node, a configuration for trigger-based RVQOE reporting or transmitting, to the network node, the configuration for trigger-based RVQOE reporting; and
transmitting at least one RVQOE report based on the configuration for trigger-based RVQOE reporting.

2. The method of claim 1, wherein the configuration indicates at least one of:
at least one first event for triggering transmitting of the RVQOE report to the network node, and
at least one second event for triggering the UE to stop transmitting the at least one RVQOE report to the network node.

3. The method of claim 2, comprising:
detecting an occurrence of the at least one first event, and
wherein the RVQOE report is transmitted based on detecting the occurrence of the event.

4. The method of claim 3, wherein detecting the occurrence of the at least one first event comprises:
comparing a first value associated with a Quality of Experience, QoE, metric or RVQOE metric to at least a first threshold; and
wherein the at least one RVQOE report is transmitted when:
the first value being below the first threshold,
the first value being above the first threshold, or
the first value being between a first threshold and a second threshold.

5. The method of claim 2, comprising:
detecting the occurrence of the at least one second event, and
stopping transmitting the at least one RRVQOE report based on detecting the occurrence of the at least one second event.

6. The method of claim 5, wherein detecting the occurrence of the at least one second event comprises:
comparing a second value associated with the QoE metric or RVQOE metric to at least the third threshold; and
wherein transmitting the at least one RVQOE report is stopped when:
the second value being below the third threshold,
the second value being above the third threshold, or
the second value being between the third threshold and a fourth threshold.

7. The method of claim 4, wherein at least one of the first value and the second value comprise a buffer level value.

8. The method of claim 3 wherein the at least one first and/or second event is detected based on at least one of:
receiving an indication from the network node that the at least one first and/or second event has been detected and/or has occurred;
detecting that a timer has expired;
detecting that at least one condition associated with a radio layer has been fulfilled; and
detecting that at least one condition associated with an application layer has been fulfilled.

9. The method of claim 1, wherein the configuration comprise at least one of:
an indication to send the at least one RVQOE report;
an indication of when to start sending the at least one RVQOE report;
an indication of a time period for sending the at least one RVQOE report;
an indication to send the at least one RVQOE report with or as part of at least one of: a Radio Link Failure report, a Random Access report, a Successful Handover report, a Successful Primary Secondary Cell Change or Addition report, and a Connection Establishment Failure report; and
an indication of when to stop sending the at least one RVQOE report.

10. The method of claim 9, wherein the indication to start sending RVQOE reports comprises an indication to start sending the at least one RVQOE report when:
a first value of at least one RVQoE metric is above a first threshold,
a first value of at least one RVQoE metric is below a first threshold,
a first value of at least one RVQoE metric is between a first threshold and a second threshold, or
a first value of at least one RVQoE metric is outside a range comprised between a first threshold and a second threshold.

11. The method of claim 8, wherein the indication of when to stop sending the at least one RVQOE report comprises an indication to stop sending the at least one RVQOE report when:
a second value of at least one RVQoE metric is above a third threshold;
a second value of at least one RVQOE metric is below a third threshold;
a second value of at least one RVQOE metric is between a third threshold and a fourth threshold; or
a value of a buffer level value is above a threshold.

12. The method of claim 1, wherein:
the configuration comprises an indication to send the at least one RVQOE report from an application layer of the UE to a radio layer of the UE; and
transmitting the at least one RVQOE report comprises transmitting the at least one RVQOE report from the application layer of the UE to the radio layer of the UE.

13. The method of claim 1, wherein:
the configuration comprises an indication to send the at least one RVQOE report from a radio layer of the UE to a network node; and
transmitting the at least one RVQOE report comprises transmitting the at least one RVQOE report from the radio layer of the UE to the network node.

14. A method by a network node for trigger-based Radio Access Network-Visible Quality of Experience, RVQOE, reporting, the method comprising:
transmitting, to a user equipment, UE, a configuration for trigger-based RVQOE reporting or receiving, from the UE, the configuration for trigger-based RVQOE reporting; and
receiving at least one RVQOE report based on the configuration for trigger-based RVQOE reporting.

15. The method of claim 14, wherein the configuration indicates at least one of:
at least one first event for triggering the UE to transmit the at least one RVQOE report to the network node, and
at least one second event for triggering the UE to stop transmitting the at least one RVQOE report to the network node.

16. The method of claim 15, comprising configuring the UE to perform at least one of:
detect an occurrence of the at least one first event and transmit the at least one RVQOE report to the network node based on detecting the occurrence of the at least one event, and
detect an occurrence of the at least one second event and stop transmitting the at least one RVQOE report based on detecting the occurrence of the at least one second event.

17. The method of claim 16, wherein configuring the UE to detect the occurrence of the at least one first event comprises configuring the UE to:
compare a first value associated with a Quality of Experience, QoE, metric or RVQOE metric to at least a first threshold, and
transmit the at least one RVQOE report when:
the first value is below the first threshold,
the first value is above the first threshold, or
the first value is between the first threshold and a second threshold.

18. The method of claim 16, wherein configuring the UE to detect the occurrence of the at least one second event comprises configuring the UE to:
compare a second value associated with a Quality of Experience, QoE, metric or RVQOE metric to at least a third threshold, and
stop transmitting the at least one RVQOE report when:
the second value is below the third threshold,
the second value is above the third threshold, or
the second value is between the third threshold and a fourth threshold.

19.-26. (canceled)

27. A user equipment, UE, for trigger-based Radio Access Network-Visible Quality of Experience, RVQOE, reporting, the UE configured to:
receive, from a network node, a configuration for trigger-based RVQOE reporting or transmit, to the network node, the configuration for trigger-based RVQOE reporting; and
transmit at least one RVQOE report based on the configuration for trigger-based RVQOE reporting.

28. (canceled)

29. A network node for trigger-based Radio Access Network-Visible Quality of Experience, RVQOE, reporting, the network node configured to:
transmit, to a user equipment, UE, a configuration for trigger-based RVQOE reporting or receive, from the UE, the configuration for trigger-based RVQOE reporting; and
receive at least one RVQOE report based on the configuration for trigger-based RVQOE reporting.

30. (canceled)
